(19) United States
(12) Patent Application Publication
(10) Pub. No.: US 2022/0097428 A1
(43) Pub. Date: Mar. 31, 2022

(54) LIQUID EJECTING APPARATUS AND MANUFACTURING METHOD OF LIQUID EJECTING APPARATUS

(71) Applicant: Seiko Epson Corporation, Tokyo (JP)

(72) Inventors: Yusaku AMANO, Matsumoto-shi (JP); Takeshi AOKI, Matsumoto-shi (JP)

(21) Appl. No.: 17/487,886

(22) Filed: Sep. 28, 2021

(30) Foreign Application Priority Data
Sep. 29, 2020 (JP) 2020-163401

(51) Int. Cl. B41J 25/00

(52) U.S. Cl. CPC B41J 25/001

(57) ABSTRACT

A printer, which is an example of a liquid ejecting apparatus, includes a movable body including a head for ejecting a liquid or a cap performing maintenance of the head. Further, the printer includes a pair of rack and pinion mechanisms including a rack and a drive gear to move the movable body in a first direction in which the rack extends; and a switching mechanism provided for each of the rack and pinion mechanisms and switching presence and absence of meshing between the rack and the drive gear when the movable body is at an exchange position.

The present application is based on, and claims priority from JP Application Serial Number 2020-163401, filed Sep. 29, 2020, the disclosure of which is hereby incorporated by reference herein in its entirety.

### BACKGROUND

### 1. Technical Field

The present disclosure relates to a liquid ejecting apparatus including a head that ejects a liquid to a medium such as paper, and a manufacturing method of the liquid ejecting apparatus.

### 2. Related Art

For example, JP-A-2020-49788 discloses a liquid ejecting apparatus including a head that ejects a liquid to a medium. The liquid ejecting apparatus includes the head capable of being lifted and lowered. When the head is lifted and lowered, the head is guided by two guide shafts to move the recording head in a third direction.

However, in the liquid ejecting apparatus described in JP-A-2020-49788, even if the head is moved along the guide shaft in order to maintain or exchange the head, the movement of the head is not smooth due to poor slidability thereof, and an operation of the maintenance or exchange of the head may be difficult. Not only the head but also a movable body of a maintenance section such as a cap has the same problem.

### SUMMARY

The liquid ejecting apparatus that solves the above problem includes a movable body including a head for ejecting a liquid or a maintenance section performing maintenance of the head; a pair of rack and pinion mechanisms including a rack and a drive gear to move the movable body in a first direction in which the rack extends; and a switching mechanism provided for each of the rack and pinion mechanisms and switching presence and absence of meshing between the rack and the drive gear when the movable body is at an exchange position.

A manufacturing method of a liquid ejecting apparatus that solves the above problems including a movable body including a head for ejecting a liquid or a cap covering a nozzle surface of the head, a pair of rack and pinion mechanisms including a rack and a drive gear to move the movable body in a first direction in which the rack extends, and a switching mechanism provided for each of the rack and pinion mechanisms and switching presence and absence of meshing between the rack and the drive gear when the movable body is at an exchange position, the method including: an inputting step of placing the movable body in a state where the rack faces the drive gear; and a meshing step of rotating the drive gear to mesh the switching mechanism so that the pair of rack and pinion mechanisms are meshed with each other in the same phase.

### BRIEF DESCRIPTION OF THE DRAWINGS

FIG. 1 is a schematic front sectional view illustrating a transport path of a medium of a printer according to an embodiment.

FIG. 2 is a schematic front view illustrating a periphery of a head unit.

FIG. 3 is a front view illustrating the periphery of the head unit.

FIG. 4 is a perspective view illustrating a structure of the periphery of the head unit.

FIG. 5 is an enlarged perspective view of the head unit.

FIG. 6 is an enlarged perspective view of a part of the head unit and a main body frame.

FIG. 7 is a perspective view illustrating the head unit and an adjustment unit.

FIG. 8 is an enlarged perspective view of a part of the head unit and the adjustment unit.

FIG. 9 is a front view illustrating a main portion of a rack and pinion mechanism, and a switching mechanism on a head side.

FIG. 10 is a front view illustrating the main portion of the rack and pinion mechanism, and the switching mechanism on the head side.

FIG. 11 is a side view illustrating the main portion of the rack and pinion mechanism, and the switching mechanism on the head side.

FIG. 12 is a front view illustrating the main portion of the rack and pinion mechanism, and the switching mechanism on the head side.

FIG. 13 is a side view illustrating the main portion of the rack and pinion mechanism, and the switching mechanism on the head side.

FIG. 14 is a side view illustrating a part of the head unit and the cap unit.

FIG. 15 is a side view illustrating the head unit and the cap unit.

FIG. 16 is a front view illustrating a guide rail.

FIG. 17 is a front view illustrating the cap unit at a first exchange position when the cap is exchanged.

FIG. 18 is a front view illustrating the cap unit at a second exchange position when the cap unit is exchanged.

FIG. 19 is a front view illustrating the main portion of the rack and pinion mechanism, and a switching mechanism on the head side.

FIG. 20 is a front view illustrating the main portion of the rack and pinion mechanism, and the switching mechanism on the head side.

FIG. 21 is a side view illustrating the main portion of the rack and pinion mechanism, and the switching mechanism on the head side.

FIG. 22 is a front view illustrating the main portion of the rack and pinion mechanism, and the switching mechanism on the head side.

FIG. 23 is a side view illustrating the main portion of the rack and pinion mechanism, and the switching mechanism on the head side.

FIG. 24 is a schematic plan view illustrating the rack and pinion mechanism, and the switching mechanism provided on the movable body in an example.

FIG. 25 is a schematic plan view illustrating a rack and pinion mechanism, and a switching mechanism provided on a movable body in a comparative example.

FIG. 26 is a schematic front sectional view illustrating a state when the head and the cap move relative to each other.

FIG. 27 is a schematic front sectional view illustrating a state when the head and the cap move relative to each other.

FIG. 28 is a schematic front sectional view illustrating a state when the head and the cap move relative to each other.

FIG. 29 is a front view illustrating the head unit at an exchange position.

FIG. 30 is a schematic front sectional view for explaining removal of the head unit.

FIG. 31 is a schematic front sectional view for explaining attachment of the head unit.

FIG. 32 is a front view for explaining an operation of the switching mechanism.

FIG. 33 is a front view for explaining the operation of the switching mechanism.

### DESCRIPTION OF EXEMPLARY EMBODIMENTS

Hereinafter, a printer 1 which is an embodiment of a liquid ejecting apparatus will be described.

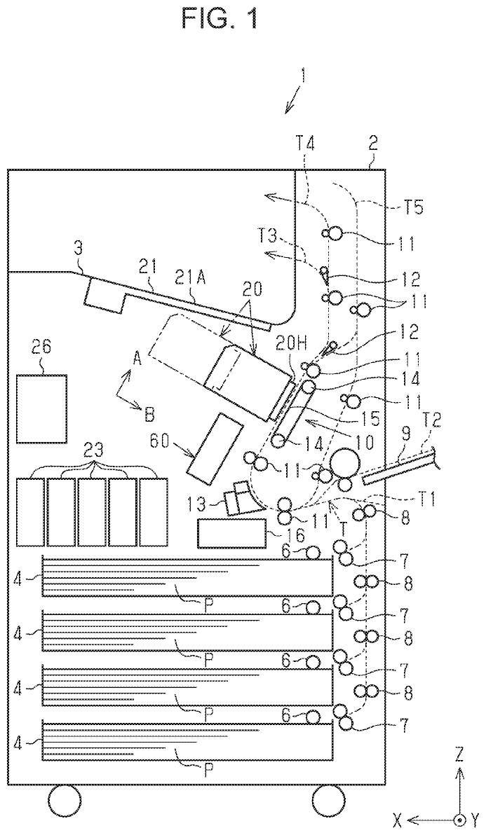

As illustrated in FIG. 1, the printer 1 as an example of a liquid ejecting apparatus is configured as an ink jet type apparatus that performs recording by ejecting ink, which is an example of a liquid, onto a medium P represented by recording paper. An X-Y-Z coordinate system illustrated in each drawing is an orthogonal coordinate system.

A Y direction is a width direction of the medium intersecting a transport direction of the medium, is an apparatus depth direction, and is, as an example, a horizontal direction. Further, the Y direction is an example of the apparatus depth direction intersecting both an A direction and a B direction which will be described later. Since this Y direction is also the width direction of the medium P being transported, it is also referred to as the width direction Y. A direction toward front in the Y direction is referred to as a +Y direction, and a direction toward back is referred to as a −Y direction.

An X direction is an apparatus width direction and, as an example, is the horizontal direction. A direction to left of the X direction when viewed from an operator of the printer 1 is referred to as a +X direction, and a direction to right is referred to as a −X direction. A Z direction is an apparatus height direction and, as an example, is a vertical direction. A lifting direction in the Z direction is referred to as a +Z direction, and a lowering direction is referred to as a −Z direction. Further, since the −Z direction is a direction in which gravity acts, it is also referred to as the gravity direction −Z.

In the printer 1, the medium P is transported through a transport path T illustrated by a broken line in FIG. 1. An A-B coordinate system illustrated on an X-Z plane is an orthogonal coordinate system. The A direction is the transport direction of the medium P in a region of the transport path T, which faces a line head 20H (hereinafter, also simply referred to as the “head 20H”) as an example of a head of a head unit 20. A direction toward upstream in the A direction is referred to as a −A direction, and a direction toward downstream is referred to as a +A direction. In the present embodiment, the A direction is a direction inclined such that the +A direction is located in the +Z direction rather than the −A direction. Specifically, it is inclined in a range of 50° to 70° with respect to the horizontal direction, and more specifically, inclined approximately 60°. As described above, the transport direction of the medium P in a region including a transport unit 10 in which the recording by the head unit 20 is performed is an inclined direction intersecting both the horizontal direction and the vertical direction.

The B direction is an example of a moving direction in which the head unit 20 having the head 20H moves. That is, the B direction is a moving direction in which the head unit 20 advances and retreats with respect to the transport unit 10. In the B direction, a direction in which the head 20H approaches the transport path T is referred to as a +B direction, and a direction away from the transport path T is referred to as a −B direction. In the −B direction, the head 20H is directed diagonally upward in the direction away from the transport unit 10. In the present embodiment, the B direction is a direction inclined such that the −B direction is located in the +Z direction rather than the +B direction, and is orthogonal to the A direction. The head unit 20 moves in the B direction along a path passing through a plurality of positions including a retracted position illustrated by a two-dot chain line in FIG. 1 and a recording position illustrated by a solid line in FIG. 1. The moving direction of the head unit 20 may be a direction forming a predetermined angle with respect to the horizontal. The moving direction of the head unit 20 is also referred to as lifting and lowering directions because the moving direction is accompanied by a displacement of the head unit 20 in the vertical direction Z due to the movement thereof and is accompanied by lifting and lowering.

The printer 1 has a rectangular parallelepiped housing 2. A discharge section 3 is formed in the +Z direction from a center of the housing 2 in the Z direction to form a space portion in which the medium P on which information is recorded is discharged. Further, a plurality of cassettes 4 are detachably provided in the housing 2. The media P are accommodated in the plurality of cassettes 4. The medium P accommodated in each cassette 4 is transported along the transport path T by a pick roller 6 and transport roller pairs 7 and 8. A transport passage T1 in which the medium P is transported from an external device and a transport passage T2 in which the medium P is transported from a manual feed tray 9 provided in the housing 2 are joined to the transport path T.

Further, in the transport path T, the transport unit 10 which is described later, a plurality of transport roller pairs 11 for transporting the medium P, a plurality of flaps 12 for switching the path in which the medium P is transported, and a medium width sensor 13 for measuring a width of the medium P in the Y direction are disposed.

The transport path T is curved in a region facing the medium width sensor 13, and extends obliquely upward from the medium width sensor 13, that is, in the A direction. Downstream of the transport unit 10 in the transport path T, a transport passage T3 and a transport passage T4 toward the discharge section 3, and a reversing passage T5 that reverses the front and back of the medium P are provided. The discharge section 3 is provided with a discharge tray (not illustrated) in accordance with the transport passage T4.

The printer 1 includes, as main portions, a transport unit 10 for transporting the medium P, a head unit 20 for recording information such as an image or a character on the medium P, and a maintenance device 60. Here, the B direction is a direction in which the head unit 20 is displaced and is a direction including a component in the Z direction that is the height direction. Further, within the housing 2, a liquid accommodation section 23 for accommodating a liquid such as ink, a waste liquid storage section 16 for storing a waste liquid of ink, and a control section 26 for controlling an operation of each portion of the printer 1 are provided. The liquid accommodation section 23 supplies ink to the head 20H via a tube (not illustrated). The head 20H ejects the liquid such as the supplied ink.

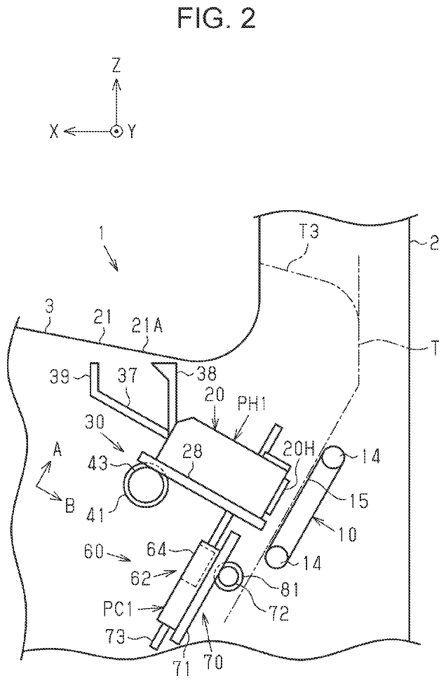

As illustrated in FIG. 1, the maintenance device 60 maintains the head 20H. The maintenance device 60 maintains the nozzle N of the head 20H. The maintenance device 60 includes a cap unit 62 having a cap 64 illustrated in FIG. 2.

As illustrated in FIG. 1, the discharge section 3 includes a discharge tray 21 constituting a bottom portion thereof. The discharge tray 21 is a plate-shaped member and has a placing surface 21A on which the discharged medium P is placed. Further, the discharge tray 21 is provided downstream of the transport unit 10 in the transport path T of the medium P and in the +Z direction with respect to the head unit 20 in the Z direction. FIG. 1 illustrates each configuration portion of the printer 1 in a simplified manner.

The control section 26 includes a central processing unit (CPU), a read only memory (ROM), a random access memory (RAM), and a storage (not illustrated). The control section 26 controls the transport of the medium P in the printer 1 and a recording operation of information on the medium P by the head unit 20. Specifically, the control section 26 is not limited to the one that performs software processing for all the processing executed by itself. For example, the control section 26 may include a dedicated hardware circuit (for example, an application-specific integrated circuit: ASIC) that performs hardware processing for at least a part of the processing executed by itself. That is, the control section 26 can be configured as a circuitry that includes one or more processors that operate according to a computer program (software), one or more dedicated hardware circuits that execute at least a part of various processes, or a combination thereof. The processor includes a CPU and a memory such as a RAM and a ROM, and the memory stores a program code or an instruction configured to cause the CPU to execute a process. A memory, that is, computer-readable media includes any available medium accessible by a general purpose or dedicated computer.

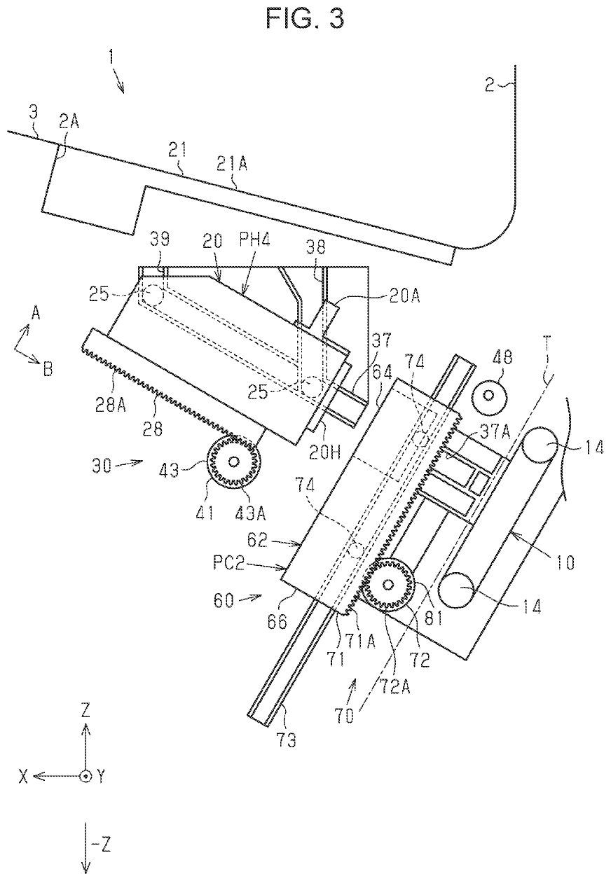

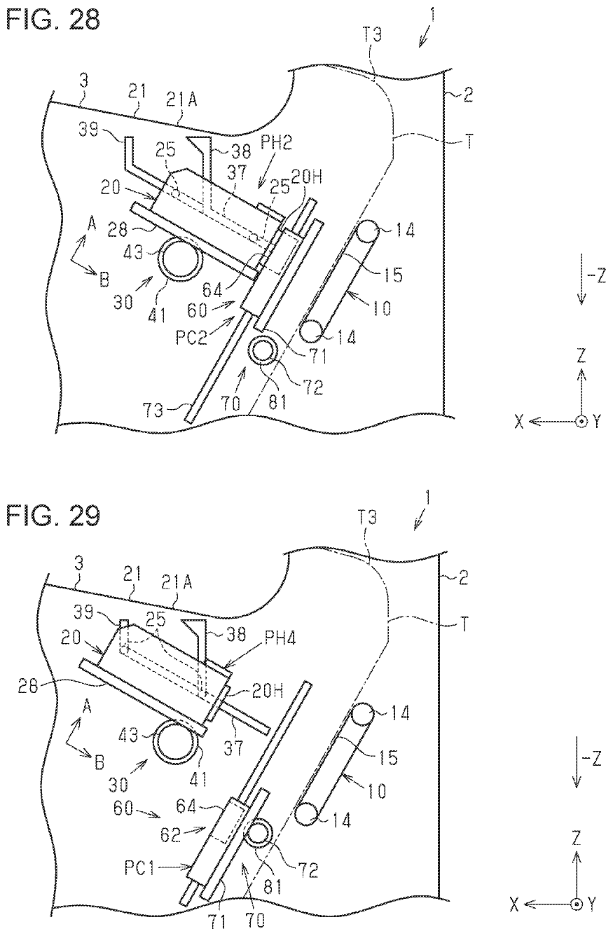

As illustrated in FIG. 2, the head unit 20 as an example of the movable body moves in the B direction that is a direction facing the transport unit 10. The head unit 20 of the present embodiment reciprocates in the moving direction inclined by a predetermined angle with respect to the horizontal plane. The head unit 20 is guided by a guide rail 37 extending in the B direction and moves in the B direction. The head unit 20 is an example of a movable body including the head 20H that ejects the liquid. By moving in the moving direction (lifting and lowering directions ±B), the head unit 20 is disposed at a recording position PH1 (FIG. 2), a cap position PH2 (FIG. 28), a retracted position PH3 (FIG. 17), an exchange position PH4 (FIG. 3), and the like.

The recording position PH1 is a position of the head unit 20 when recording is performed on the medium P. The cap position PH2 is a position of the head unit 20 when capping is performed so that the nozzle surface 20N of the head 20H is covered with the cap 64. Since the head unit 20 stands by in a state of being capped on the head 20H when the recording is not performed, the cap position PH2 is also a standby position of the head unit 20. The retracted position PH3 is a position where the head unit 20 is temporarily retracted from the recording position to the lifting side at a position that does not hinder the movement of the cap unit 62 when the cap unit 62 moves in the A direction. The retracted position PH3 is located on the −A direction side with respect to the cap position PH2. The exchange position PH4 is a position when the head unit 20 is exchanged. The exchange position PH4 is a position on the −A direction side with respect to the retracted position PH3. The exchange position PH4 is a position when the head unit 20 is exchanged. The exchange position PH4 is located on a side (−B direction side) where the head unit 20 lifts from the retracted position PH3. As illustrated in FIG. 2, the printer 1 is provided with exchange guide rails 38 and 39 for removing and attaching the head unit 20 from and to the housing 2 (apparatus main body) at the exchange position PH4.

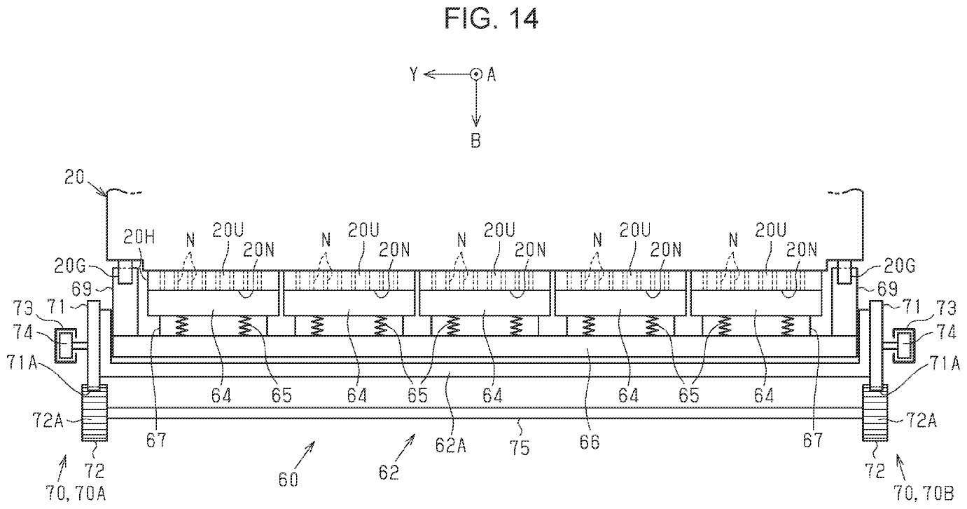

The head unit 20 of the present embodiment lifts diagonally upward in the −B direction inclining at the predetermined angle θ1 with respect to the horizontal plane, and lowers diagonally downward in the +B direction inclining at the predetermined angle θ1 with respect to the horizontal plane. That is, directions orthogonal to the nozzle surface 20N, which is the surface on which the nozzle N (see FIG. 14) is open in the head 20H, are the lifting and lowering directions of the head 20H. In the present specification, the directions in which the head unit 20 moves are also referred to as the lifting and lowering directions. In the present specification, the lifting and lowering directions including the −B direction and the +B direction are also referred to as the lifting and lowering directions ±B.

As illustrated in FIGS. 2 and 3, the printer 1 includes a rack and pinion mechanism 30 as a moving mechanism for moving the head unit 20 in the B direction. The rack and pinion mechanism 30 is configured to include, for example, a drive gear 43 and a rack 28. A length of the rack 28 is longer than a length of one circumference of the drive gear 43. The printer 1 has a motor 41 as a drive source of the drive gear 43. By driving the motor 41, the head unit 20 moves in the B direction via the rack and pinion mechanism 30. The head unit 20 is guided by a guide rail 37 extending in the B direction and moves in the B direction. The rack and pinion mechanism 30 lifts and lowers the head unit 20 in the lifting and lowering directions ±B.

The maintenance device 60 illustrated in FIG. 2 stores the head 20H and performs maintenance of the head 20H. The maintenance device 60 includes the cap unit 62 having the cap 64 that covers the head 20H, and a wiper unit (not illustrated) that performs cleaning by wiping the nozzle surface 20N in the head 20H.

The cap unit 62 as an example of the movable body is provided so as to be movable in the A direction that intersects (for example, orthogonal) the B direction that is the moving direction of the head unit 20. The cap unit 62 is guided by a guide rail 73 extending in the A direction and reciprocates in the A direction. The cap unit 62, which is an example of the maintenance unit, is an example of the movable body including the cap 64 as an example of the maintenance section that performs maintenance of the head 20H.

As illustrated in FIG. 2, the printer 1 includes a rack and pinion mechanisms 70, as a moving mechanism, that moves the cap unit 62 in the A direction intersecting (for example, orthogonal) the B direction that is the moving direction of the head unit 20. A pair of rack and pinion mechanisms 70 are provided with respect to the cap unit 62 in the width direction Y intersecting the A direction that is the moving direction thereof. The rack and pinion mechanism 70 includes a rack 71 and a drive gear 72, and moves the head unit 20, which is an example of the movable body, in a first direction (direction A) in which the rack 28 extends. A length of the rack 71 is longer than a length of one circumference of the drive gear 72. The drive gear 72 is driven by power of a motor 81 that is a drive source of the rack and pinion mechanism 70.

The cap unit 62 can be reciprocated in the A direction by the rack and pinion mechanisms 70. The cap unit 62 reciprocates in the A direction along a linear path passing through a plurality of positions including a standby position PC1 illustrated in FIGS. 1 and 2 and a capping position PC2 (see FIGS. 27 and 28) where the cap 64 faces the head 20H.

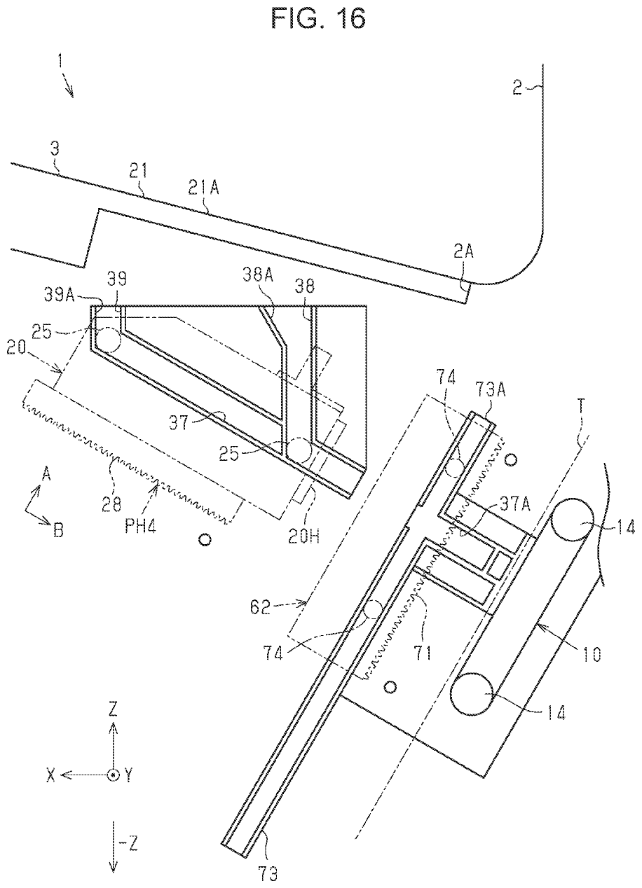

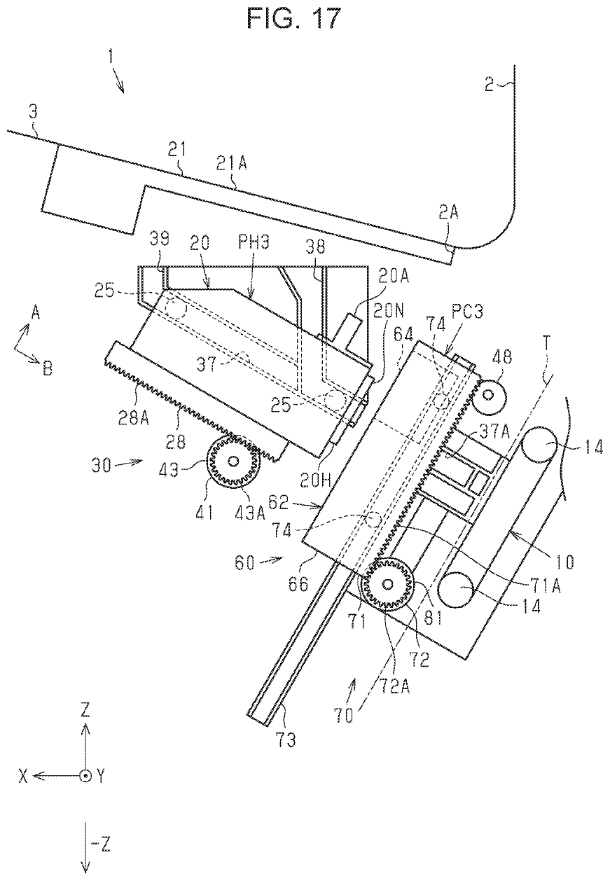

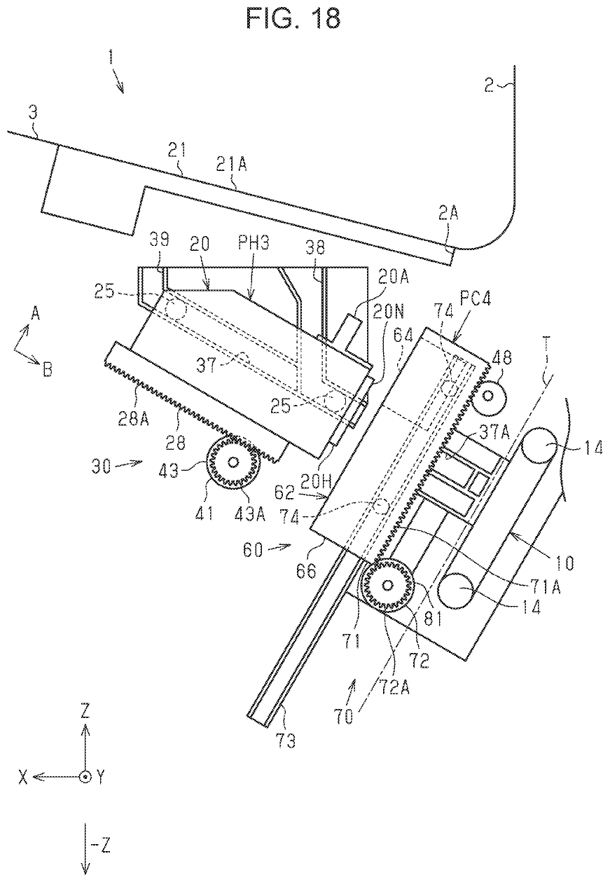

Specifically, the cap unit 62 moves to the standby position PC1 (FIG. 2), the capping position PC2 (FIG. 3), a first exchange position PC3 (FIG. 17), and a second exchange position PC4 (FIG. 18). The standby position PC1 is a position where the cap unit 62 stands by when the head unit 20 performs the recording. The capping position PC2 is a position of the cap unit 62 when capping is performed so as to cover the nozzle surface 20N of the head 20H. The first exchange position PC3 is a position of the cap unit 62 when the cap 64 is exchanged. The cap unit 62 is configured such that only the cap 64 can be exchanged, and when the cap 64 is exchanged, the cap unit 62 is disposed at the first exchange position PC3. The second exchange position PC4 is a position of the cap unit 62 when the cap unit 62 is exchanged.

When the cap unit 62 moves from the standby position to the capping position, the head unit 20 moves to the retracted position PH3 retracted in the −B direction from the recording position PH1 in order to secure a movement path of the cap unit 62. When the head unit 20 is at the retracted position PH3, the cap unit 62 moves to the capping position PC2 (see FIG. 27) in the +A direction. The capping position PC2 is a position where the cap 64 illustrated in FIG. 2 faces the head 20H in the B direction when being at the retracted position PH3. After that, when moving from the retracted position PH3 in the +B direction, the head unit 20 is disposed at the cap position PH2 (see FIG. 28) where the head 20H abuts against the cap 64 at the capping position PC2 with a predetermined pressure. At the cap position PH2 where the head 20H abuts against the cap 64, the cap 64 covers the nozzle N of the head 20H.

Maintenance of the head 20H is performed under a state where the cap 64 covers the nozzle N of the head 20H. The head 20H forcibly discharges the liquid such as ink from the nozzle N into the cap 64. In the printer 1, the cap unit 62 stores the liquid forcibly discharged from the head 20H in the waste liquid storage section 16 illustrated in FIG. 1 as the waste liquid. The waste liquid storage section 16 stores, as the waste liquid, the liquid such as ink idle-ejected for maintenance from the head 20H toward the cap 64 (see FIGS. 14 and 27), and the liquid such as ink forcibly discharged from the nozzle N of the head 20H by cleaning.

As illustrated in FIGS. 1 to 3, the transport unit 10 is an example of a support section that supports the medium P (see FIG. 1) being transported. The transport unit 10 may have two pulleys 14, an endless transport belt 15 wound around the two pulleys 14, and a motor (not illustrated) for driving the pulleys 14. The medium P is transported at a position facing the head unit 20 while being adsorbed to a belt surface of the transport belt 15. As a method of adsorbing the medium P on the transport belt 15, a known adsorption method such as an air suction method or an electrostatic adsorption method can be adopted. As described above, the transport belt 15 supports the medium P while adsorbing the medium P. The transport unit 10 is disposed to face the head unit 20 in the B direction.

The head unit 20 has the line head 20H that ejects ink which is an example of the liquid. The line head 20H is disposed to face the transport unit 10 in the B direction at the recording position, and information is recorded on the medium P by ejecting ink from the head 20H. The head unit 20 is an ink ejecting head configured such that the head 20H for ejecting ink covers the entire region of the medium P in the Y direction as the width direction thereof. Further, the nozzle surface 20N of the head 20H is disposed in the A direction and the Y direction. The nozzle surface 20N is a surface on which the nozzle N (see FIG. 14) for ejecting the liquid in the head 20H is open.

Further, the head unit 20 is configured as an ink ejecting head capable of recording in the entire region of the medium P in the width direction thereof without moving in the width direction of the medium P. However, the type of the ink ejecting head is not limited to this, and may be the head 20H which is a type mounted on a carriage and ejects ink while moving in the width direction of the medium P.

As illustrated in FIG. 3, a plurality of guide rollers 25 formed of rollers are rotatably provided on a side surface of the head unit 20. When the plurality of guide rollers 25 are guided by the guide rail 37, the head unit 20 moves along the guide rail 37.

In the printer 1 of the present embodiment, the head unit 20 and the cap unit 62 can be exchanged by an operator such as a user. In FIG. 3, the head unit 20 is disposed at the exchange position PH4. When the operator exchanges the head unit 20, if an operation for designating the exchange is performed by using an operation panel (not illustrated), the control section 26 reversely drives the motor 41 to move the head unit 20 to the exchange position PH4.

As illustrated in FIG. 3, the guide rails 38 and 39 as an example of a first guide portion for guiding the movable body and the guide rail 37 as an example of a second guide portion are provided. The guide rails 38 and 39 extend from the exchange position PH4 of the head unit 20 in a second direction (A direction) intersecting the first direction (B direction) in which the rack 28 extends. The guide rail 37 extends from the exchange position PH4 in the first direction (A direction).

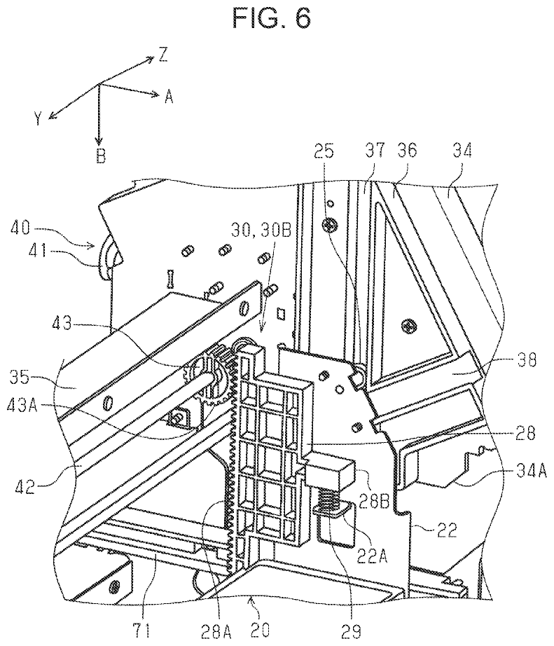

As illustrated in FIG. 3, the head unit 20 can be separated from meshing of the rack and pinion mechanism 30 at the exchange position PH4 farthest from the transport unit 10 (see FIG. 1) in the B direction. Specifically, the head unit 20 is pulled up in the +Z direction along the guide rails 38 and 39 (see also FIG. 6) at the exchange position PH4 moved in the −B direction along the guide rail 37 (see also FIG. 6) thereby being separated from the meshing of the rack and pinion mechanism 30.

When the head unit 20 illustrated in FIG. 3 is at the exchange position PH4, the plurality of guide rollers 25 are located at the intersections of the two guide rails 38 and 39 extending in the vertical direction Z and the guide rails 37 extending in the B direction. When the head unit 20 is at the exchange position PH4, the guide roller 25 can move in the vertical direction Z along the two guide rails 38 and 39, so that the head unit 20 can be removed and attached from and to the housing 2.

When the head unit 20 is at the exchange position PH4 illustrated in FIG. 3, the discharge tray 21 is located above the head unit 20. By removing the discharge tray 21, an input opening 2A, which is an opening for input when the head is exchanged, is exposed to an upper portion of the housing 2. The head unit 20 is removed and attached by the operator moving the head unit 20 from the input opening 2A in the vertical direction Z while guiding the guide rollers 25 to the guide rails 38 and 39.

As illustrated in FIG. 3, the rack and pinion mechanism 30 is in a state where a tooth portion 43A of the drive gear 43 and a tooth portions 28A of the rack 28 mesh with each other. When the head unit 20 is at the exchange position PH4, the drive gear 43 meshes with the rack 28 at an end portion on a +B direction side in a longitudinal direction thereof. When the motor 41 is forward driven, the drive gear 43 rotates in a clockwise direction in FIG. 3 and the head unit 20 lowers in the +B direction. On the other hand, when the motor 41 is reversely driven, the drive gear 43 rotates in a counterclockwise direction in FIG. 3 and the head unit 20 lifts in the −B direction.

Further, as illustrated in FIG. 3, a plurality of guide rollers 74 formed of rollers are rotatably provided on the side surface of the cap unit 62. When the plurality of guide rollers 74 are guided by the guide rail 73, the cap unit 62 moves along the guide rail 73.

When the operator exchanges the cap unit 62, an operation for designating the exchange is performed by using the operation panel (not illustrated). When receiving an operation signal from the operation panel, the control section 26 forward drives the motor 81 to move the cap unit 62 to the exchange position. In the present example, only the cap 64 that is a part thereof can be exchanged, and the entire cap unit 62 can be exchanged.

When exchanging only the cap 64, the cap unit 62 moves to the first exchange position PC3 illustrated in FIG. 17. Further, when the cap unit 62 is exchanged, the cap unit 62 moves to the second exchange position PC4 illustrated in FIG. 18. The input opening (not illustrated) for exchanging the cap unit 62 is located near an extension line of the guide rail 73 in the +A direction, and the cap 64 or the cap unit 62 can be removed and attached from and to the housing 2 via the input opening.

As illustrated in FIG. 3, the cap unit 62 can be separated from the meshing with the rack and pinion mechanism 70 at the second exchange position PC4. Specifically, the cap unit 62 is pulled up from the end portion of the guide rail 73 (see also FIG. 6) in the +A direction along the guide rail 73 at the second exchange position PC4, so that the meshing with the rack and pinion mechanism 70 can be separated.

As illustrated in FIG. 3, the rack and pinion mechanism 70 is in a state where the tooth portion 72A of the drive gear 72 and the tooth portion 71A of the rack 71 mesh with each other. When the motor 81 is forward driven, the drive gear 72 rotates in the clockwise direction in FIG. 3 and the cap unit 62 lifts in the +A direction. On the other hand, when the motor 81 is reversely driven, the drive gear 72 rotates in the counterclockwise direction in FIG. 3 and the cap unit 62 lowers in the −A direction.

Here, the “lifting and lowering” used for the movement of the movable body in the present specification refers to the movement of the head 20H capable of parallel moving the nozzle surface 20N in the direction intersecting the nozzle surface 20N of the head 20H. Further, it refers to the movement with the displacement of the head unit 20 in the vertical direction Z. In the present embodiment, the lifting and lowering refer to the movement of the head unit 20 in the B direction. Further, the “lifting and lowering” refer to the movement of the cap unit 62 capable of parallel moving an opening surface of the cap 64 in a direction intersecting the opening surface of the cap 64. Further, it refers to the movement with the displacement of the cap unit 62 in the vertical direction Z. In the present embodiment, the lifting and lowering indicate the movement of the cap unit 62 in the A direction.

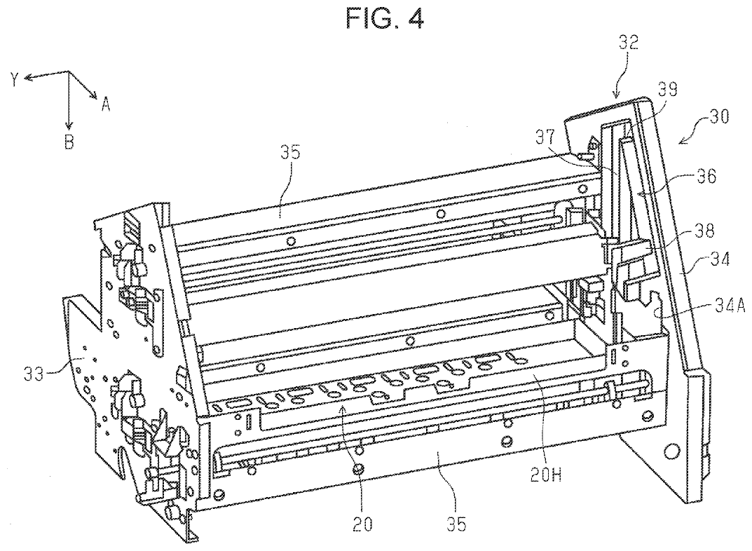

The printer 1 has, within the housing 2, a main body frame 32 constituting a main body portion illustrated in FIG. 4, a guide member 36 for guiding the head unit 20 in the lifting and lowering directions ±B, and a drive unit 40 (see FIG. 6) that drives the head unit 20 in the lifting and lowering directions ±B. The rack and pinion mechanism 30 moves the head unit 20 to one or more positions away from the transport unit 10 with respect to the recording position. Specifically, the rack and pinion mechanism 30 is provided such that the head unit 20 can be moved to the recording position, the retracted position, the cap position, and the exchange position.

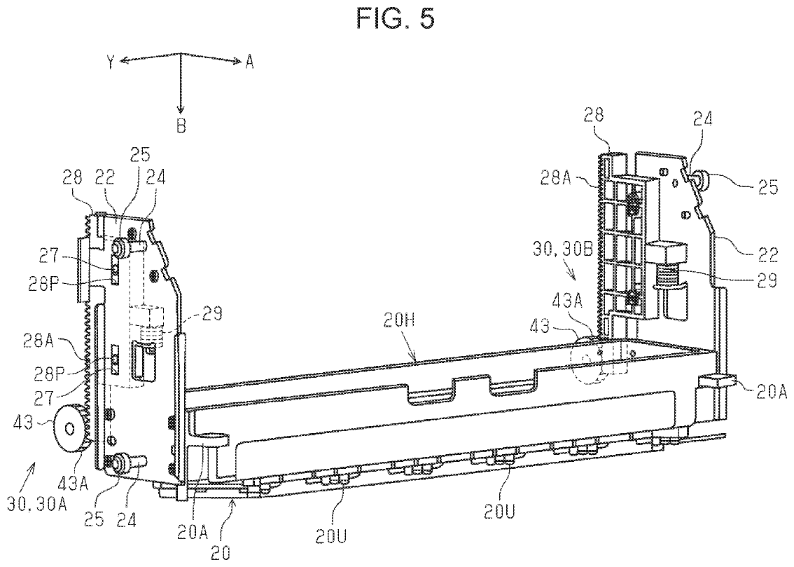

As illustrated in FIG. 5, the head 20H included in the head unit 20 extends in the Y direction. A pair of plate portions 20A protrude in the +A direction in both end portions of the head 20H in the Y direction. The head unit 20 has the head 20H and a pair of support frames 22 attached to both end portions of the head 20H in the Y direction.

The support frame 22 is configured as a side plate along an A-B plane and extends in the −B direction with respect to the head unit 20. Cylindrical support pins 24 respectively extending in the +Y direction and the −Y direction are provided at both end portions, in the B direction, of the support frame 22 on an outer surface in the Y direction. The support pin 24 is provided such that a guide roller 25 formed of an annular roller can be rotated.

As illustrated in FIG. 5, the printer 1 includes the rack and pinion mechanism 30 for moving the head unit 20. The rack and pinion mechanism 30 includes the rack 28 and the drive gear 43, and moves the head unit 20, which is an example of the movable body, in the first direction (A direction) in which the rack 28 extends. The drive gear 43 is driven by the power of the motor 41 that is a drive source of the rack and pinion mechanism 30.

As illustrated in FIG. 5, the head unit 20 is provided with a pair of rack and pinion mechanisms 30 on both sides in the width direction Y intersecting the lifting and lowering directions ±B that are the moving directions. In the example of FIG. 5, a first rack and pinion mechanism 30A is provided at the end portion on the +Y direction side with respect to the head unit 20, and a second rack and pinion mechanism 30B is provided at the end portion on the −Y direction side with respect to the head unit 20.

As described above, the pair of rack and pinion mechanisms 30 include the first rack and pinion mechanism 30A and the second rack and pinion mechanism 30B. The first rack and pinion mechanism 30A and the second rack and pinion mechanism 30B are provided on one end side and the other end side of the head unit 20 in the width direction Y. Here, the width direction Y corresponds to a third direction. The third direction is a direction intersecting both the B direction that is the first direction and the Z direction that is the second direction, and is the Y direction. The first direction is the moving direction (B direction) of the head unit 20, and is an extending direction of the rack 28. The second direction is a guide direction in which the head unit 20 is guided from the input opening 2A to the exchange position PH4 along the guide rails 38 and 39 when the head unit 20 is exchanged. Since there are the pair of rack and pinion mechanisms 30A and 30B on both sides of the head unit 20 in the width direction Y, the head unit 20 can be lifted and lowered in a stable posture. When it is not necessary to distinguish the pair of rack and pinion mechanisms 30A and 30B, it is simply referred to as the “rack and pinion mechanism 30”.

Further, the rack 28 having a pin 28P is provided on the inner surface of the support frame 22 in the Y direction. The pin 28P protrudes outward from the rack 28 in the Y direction. The rack 28 is a plate-shaped member of which a thickness direction is the Y direction and extends in the B direction. At an end portion of the rack 28 in the −A direction, the tooth portion 28A having a plurality of teeth arranged in the B direction is formed.

Further, the head unit 20 is formed with an elongated hole 27 which penetrates in the Y direction and is long in the B direction. The pin 28P is inserted through the elongated hole 27. Therefore, the rack 28 can move relative to the support frame 22 in the B direction. That is, the rack 28 can move relative to the head unit 20 in a range in which the pin 28P can move within the elongated hole 27 in the B direction. In the present example, a slide mechanism is configured of the pin 28P and a portion including the elongated hole 27 into which the pin 28P is inserted. The slide mechanism allows the rack 28 to move relative to the head unit 20 in the B direction.

Further, as illustrated in FIGS. 5 and 6, a second spring 29 is interposed between the rack 28 and the head unit 20. The second spring 29 is, for example, a compression spring. The second spring 29 urges so as to separate the rack 28 and the head unit 20 in the B direction. Therefore, when the rack 28 is moved in the B direction under a state where the movement of the head unit 20 in the B direction, which is the lowering direction thereof, is regulated, the rack 28 moves relative to the head unit 20 in a direction approaching the head 20H with compressive deformation of the second spring 29. In FIGS. 5 and 6, the head unit 20 is in a state of being slid in the B direction with respect to the rack 28 due to a self-weight thereof and an urging force of the second spring 29. Further, the self-weight of the head unit 20 and the second spring 29 are urged so as to separate the rack 28 and the head unit 20 in the B direction. However, the pin 28P abuts against an upper end surface of the elongated hole 27, so that further slide of the head unit 20 with respect to the rack 28 is regulated in the +B direction. In a state where the head unit 20 slides most with respect to the rack 28 in the +B direction, the second spring 29 is in a state of being slightly compressed from a natural length thereof. The second spring 29 may be a tension spring or a torsion coil spring. Further, the second spring 29 is not limited to the configuration of being pulled by the weight of the head unit 20, and may be interposed between the head unit 20 and the rack 28 in a configuration of being compressed by the weight of the head unit 20.

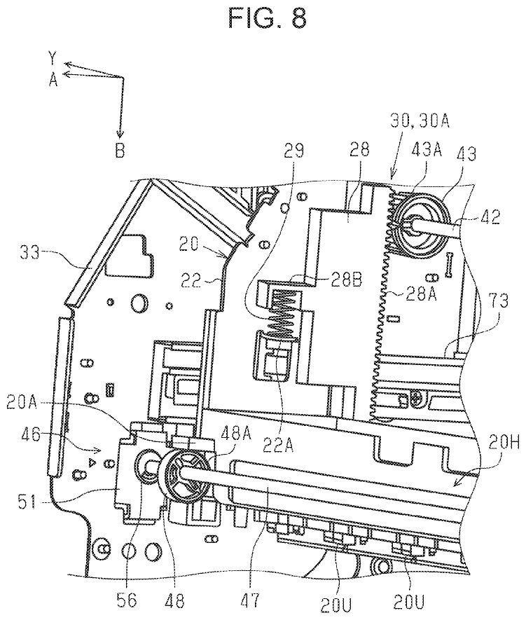

As illustrated in FIGS. 5 to 8, one end portion of the second spring 29 is attached to the support frame 22 and the other end portion is attached to the rack 28. Specifically, as illustrated in FIG. 8, a first hooking portion 28B extends horizontally from the rack 28 and a second hooking portion 22A extends horizontally from an inner surface of the support frame 22. The first hooking portion 28B and the second hooking portion 22A face each other with an interval in the B direction, one end portion of the second spring 29 is hooked on the first hooking portion 28B, and the other end portion is hooked on the second hooking portion 22A.

Here, with reference to FIGS. 4 and 6, a configuration of the main body frame 32 to which the rack and pinion mechanism 30 and the head unit 20 are assembled will be described. As illustrated in FIG. 4, the main body frame 32 has side frames 33 and 34, and a plurality of horizontal frames 35. The side frames 33 and 34 are respectively configured as side plates along the A-B plane, and are disposed to face each other with an interval in the Y direction. The side frame 33 is disposed on the +Y direction side and the side frame 34 is disposed on the −Y direction side. The side frame 34 is formed with a through-hole 34A for moving a wiper unit (not illustrated).

The plurality of horizontal frames 35 couple the side frames 33 and 34 in the Y direction. Further, the head unit 20 is disposed in a space surrounded by the plurality of horizontal frames 35. One guide member 36 is provided on each of the side frames 33 and 34. The two guide members 36 are disposed substantially symmetrically with respect to a center of the main body frame 32 in the Y direction. Therefore, the guide member 36 on the −Y direction side will be described and the description of the guide member 36 in the +Y direction will be omitted.

As illustrated in FIG. 6, the guide member 36 is attached to a side surface of the side frame 34 in the +Y direction. The guide member 36 is formed with the guide rail 37 extending in the B direction and the guide rail 38 branching from a portion in the middle of the guide rail 37 and extending in the Z direction. The guide rails 37 and 38 are both grooves that are open in the +Y direction, and guide the guide roller 25 (see FIG. 5) of the head unit 20 in the B direction or the Z direction.

As illustrated in FIG. 4, the end portion of the guide rail 37 in the −B direction may be bent in the +Z direction to form the short guide rail 38 (see FIG. 4). Further, a portion of the guide member 36 in the −Y direction, which overlaps the through-hole 34A in the Y direction, is removed. In other words, the guide member 36 is also provided in the +B direction with respect to the through-hole 34A. Therefore, the guide rail 37 in the −Y direction is divided into two with a space of a portion corresponding to the through-hole 34A therebetween.

As illustrated in FIG. 6, a set of guide rails 73 are provided on the set of side frames 33 and 34. The set of guide rails 73 are formed in a groove shape that is open inward in the Y direction, and extend in the A direction. Further, the set of guide rails 73 support the guide roller 74 (see FIG. 3) configured of a plurality of rollers provided on the side surface of the cap unit 62 so as to be movable in the A direction. That is, the cap unit 62 (see FIG. 2) can be moved in the A direction by guiding the plurality of guide rollers 74 by the guide rail 73 in the A direction.

As illustrated in FIG. 6, the drive unit 40 is configured to include the motor 41, a gear portion (not illustrated), a shaft (rotation shaft) 42, and the drive gear 43. The drive unit 40 is drive-controlled by the control section 26 (see FIG. 1). The shaft 42, which is rotated by power of the motor 41, is rotatably supported by the set of side frames 33 and 34 at both end portions thereof in a state of being extended in the Y direction. The drive gears 43 are attached to both end portions of the shaft 42 in the Y direction. The tooth portion 43A that meshes with the tooth portion 28A of the rack 28 is formed on an outer peripheral portion of the drive gear 43.

The motor 41 rotates the shaft 42 and the drive gear 43 in one direction or the opposite direction via the gear portion (not illustrated). As described above, the drive unit 40 rotationally drives the drive gear 43 to allow the head unit 20 to reciprocate in the B direction.

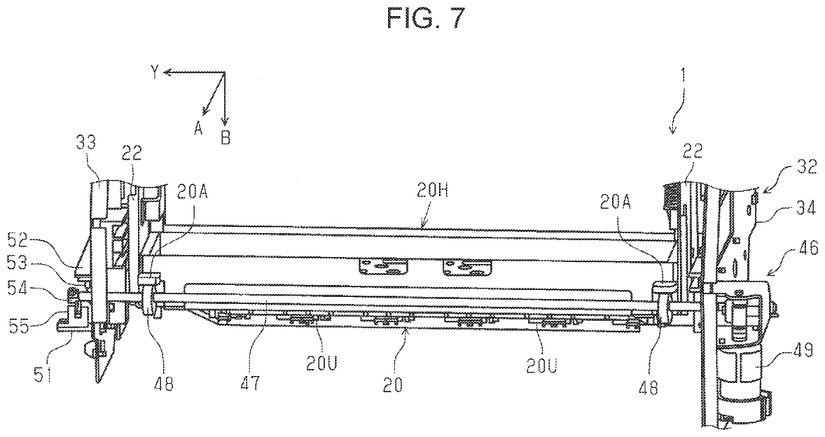

As illustrated in FIG. 7, the main body frame 32 is provided with an adjustment unit 46. The adjustment unit 46 includes a cam shaft 47, two eccentric cams 48, a motor 49, a holder 51, a bracket 52, an adjustment screw 53, a detected member 54, and a position sensor 55. As described above, the adjustment unit 46 includes the eccentric cams 48 and the cam shaft 47 as an example of a shaft for rotating the eccentric cam 48.

The cam shaft 47 is a member long in the Y direction and extends from the side frame 33 to the side frame 34. The two eccentric cams 48 are attached to the cam shaft 47. Outer peripheral surfaces of the two eccentric cams 48 are cam surfaces 48A (see FIG. 8). As illustrated in FIG. 7, the outer peripheral surface of the eccentric cam 48 is in contact with a portion of the plate portion 20A of the head unit 20 in the +B direction. Therefore, the two eccentric cams 48 are rotated with the rotation of the cam shaft 47, so that the position of the head 20H is adjusted in the B direction. Further, the motor 49 is driving-controlled by the control section 26 (see FIG. 1) to rotate the cam shaft 47 in one direction or the opposite direction.

The eccentric cam 48 illustrated in FIG. 8 has a cam surface 48A of which a surface facing a direction opposite to the direction in which the nozzle surface 20N of the head 20H faces is an example of the regulation surface. That is, the eccentric cam 48 has the cam surface 48A that switches the presence and absence of the contact with the head 20H by moving the head unit 20 in the lifting and lowering directions ±B. One end portion of the cam shaft 47 is inserted into a bearing 56 movably inserted into the through-hole of the holder 51 attached to the side frame 33.

As illustrated in FIG. 7, at the end portion of the adjustment unit 46 on the +Y direction side, a shaft end portion of the adjustment screw 53 supported by the bracket 52 is engaged with a screw hole of the holder 51. By rotating the adjustment screw 53 to move the holder 51 up and down, the position of the cam shaft 47 in the B direction and the position of the head unit 20 in the B direction can be adjusted. In the present example, the position of the eccentric cam 48 in the B direction can be adjusted by a manual operation of the adjustment screw 53 by an operator.

The detected member 54 attached to the end portion of the cam shaft 47 has a fan-shaped portion that protrudes from the cam shaft 47 in a radial direction. The position sensor 55 attached to the holder 51 is, for example, an optical sensor including a light emitting portion and a light receiving portion (not illustrated). The position sensor 55 detects a rotation angle of the cam shaft 47 based on the presence and absence of light blocking by the fan-shaped portion of the detected member 54. The control section 26 drives the motor 49 based on the rotation angle of the cam shaft 47 detected by the position sensor 55 to adjust the rotation angle of the eccentric cam 48. In the present embodiment, the lowering of the head unit 20 is stopped in a state where the plate portion 20A of the head 20H is in contact with the cam surface 48A of the eccentric cam 48. Therefore, the head 20H is disposed at the recording position.

The recording position of the head unit 20 illustrated in FIGS. 7 and 8 is determined according to a required gap, which is an interval between the head unit 20 and the transport unit 10 (see FIG. 1) in the B direction. The recording position is determined according to the medium type which is the type of the medium P. After the rotation of the eccentric cam 48, the drive unit 40 moves the head unit 20 in the B direction so that the plate portion 20A comes into contact with the eccentric cam 48. At this time, the compressive deformation of the second spring 29 absorbs an error of the stop position of the rack 28. After the drive unit 40 moves the head unit 20 in the B direction and the plate portion 20A comes into contact with the eccentric cam 48, the eccentric cam 48 may be rotated to position the head unit 20 at the recording position.

As described above, the recording position of the head 20H in the lifting and lowering directions ±B can be switched in a plurality of stages according to the rotation angle of the eccentric cam 48. In the present embodiment, the recording position of the head 20H is switchable to a plurality of stages within the range of, for example, 3 to 6 stages. In the head 20H, a gap, which is an interval between the nozzle surface 20N and the transport unit 10 in the opposite direction, is adjusted according to the recording position at that time. The head 20H ejects the liquid toward the medium P transported by the transport unit 10 under a state where an appropriate gap is secured.

Next, the directions regarding the movement and exchange of the movable body will be described. In the directions related to the movable body, there are three directions in which a. a moving direction when the rack and pinion mechanism moves in a meshed state, b. a guide direction in which the movable body is guided when the movable body is removed and attached due to the exchange thereof before the rack and pinion mechanism meshes, and c. an input direction when the movable body is inputted from the input opening for attachment at the exchange position. The cap unit 62 of the present embodiment does not include an induction guide rail for guiding the cap unit 62 to the exchange position before the rack and pinion mechanism meshes, so that there is no guide direction.

First, the three directions related to the head unit 20 will be described. First, the moving direction will be described. The guide roller 25 of the head unit 20 is guided by the guide rail 37. The rotation of the drive gear 43 causes the rack 28 to move the head unit 20 in the moving direction. The moving direction of the head unit 20 determined by the guide rail 37 and the rack and pinion mechanism 30 is the B direction.

Next, the guide direction at the time of exchange will be described. The guide rollers 25 are guided by the guide rails 38 and 39. The movement of the head unit 20 is manually performed by the user. The end (lower end) of the guide rail 38 and the start end (end on the −B side) of the guide rail 37 meet, and the angles of the guide rail 37 and the guide rails 38 and 39 are different from each other. The extending direction of the guide rails 38 and 39 is the guide direction. The guide direction of the head unit 20 is the vertical direction Z.

Next, the input direction when the head unit 20 is attached will be described. The input direction is a direction that intersects (for example, orthogonal) the moving direction of the head unit 20. In the present example, the input direction is equal to the guide direction. The input direction is the vertical direction Z. When the head unit 20 is at the exchange position PH4 illustrated in FIG. 3, the discharge tray 21 is located above the head unit 20, and by removing the discharge tray 21, the input opening 2A that is an opening for input when the head is exchanged is exposed to the upper portion of the housing 2. From the input opening 2A, the operator inputs the head unit 20 in the gravity direction −Z while guiding the guide roller 25 to the guide rails 38 and 39. Therefore, the input direction of the head unit 20 is the gravity direction −Z.

Next, the two directions related to the cap unit 62 will be described.

First, the moving direction will be described. The guide roller 74 of the cap unit 62 is guided by the guide rail 73. The rack 71 moves in the A direction due to the rotation of the drive gear 72 on the main body side, so that the cap unit 62 fixed to the rack 71 moves along the guide rail 73 in the A direction. Therefore, the moving direction of the cap unit 62 in the meshed state of the rack and pinion mechanism 70 is the A direction.

Next, the input direction will be described. Since the cap unit 62 is input along the guide rail 73, the input direction is the same as the moving direction. The cap unit 62 is input in the −A direction from the input opening (not illustrated) located near the extension line of the guide rail 73 in the +A direction. In the input opening, since the insertion opening at the end portion of inserting the guide roller 74 into the guide rail 73 faces the input opening side, the cap unit 62 is input while a plurality of guide rollers 74 are fitted in from the insertion opening at the end portion of the guide rail 73 via the input opening. The input direction of the cap unit 62 is the −A direction.

The printer 1 may include an induction guide rail for inducing the cap unit 62 to the second exchange position PC4 when the cap unit 62 is attached to the apparatus main body. In this case, the guide rail 73 may be extended in the extending direction to serve as the induction guide rail, or an induction guide rail extending in a direction different from the extending direction of the guide rail 73 may be extended from the end portion of the guide rail 73.

In the present embodiment, a switching mechanism 31 is provided for each rack and pinion mechanism 30. The switching mechanism 31 switches the presence and absence of the meshing between the rack and the drive gear when the head unit 20, which is an example of the movable body, is at the exchange position PH4. In the present embodiment, a switching mechanism 76 is provided for each rack and pinion mechanism 70. The switching mechanism 76 switches the presence and absence of the meshing between the rack 71 and the drive gear 72 when the cap unit 62, which is an example of the movable body, is at the input position (exchange position at the time of attaching) near the second exchange position PC4.

The switching mechanism 31 has a function of switching the presence and absence of the meshing of the pair of rack and pinion mechanisms when the head unit 20 is input in a state where the tooth portion 28A of the rack 28 is placed on the tooth portion 43A of the drive gear 43. The switching mechanism 31 adjusts a phase when performing the meshing such that the pair of rack and pinion mechanisms 30 are meshed with each other in the same phase. Similarly, the switching mechanism 76 adjusts the phase when performing the meshing such that the pair of rack and pinion mechanisms 70 are meshed with each other in the same phase. The switching mechanism 31 includes a plug-in key as an example of the tooth portion provided on one of the rack 28 and the drive gear 43, and a groove provided on the other side and capable of meshing with the plug-in key as an example of the tooth portion. The switching mechanism 76 includes a plug-in key as an example of the tooth portion provided on one of the rack 71 and the drive gear 72, and a groove provided on the other side and capable of meshing with the plug-in key as an example of the tooth portion.

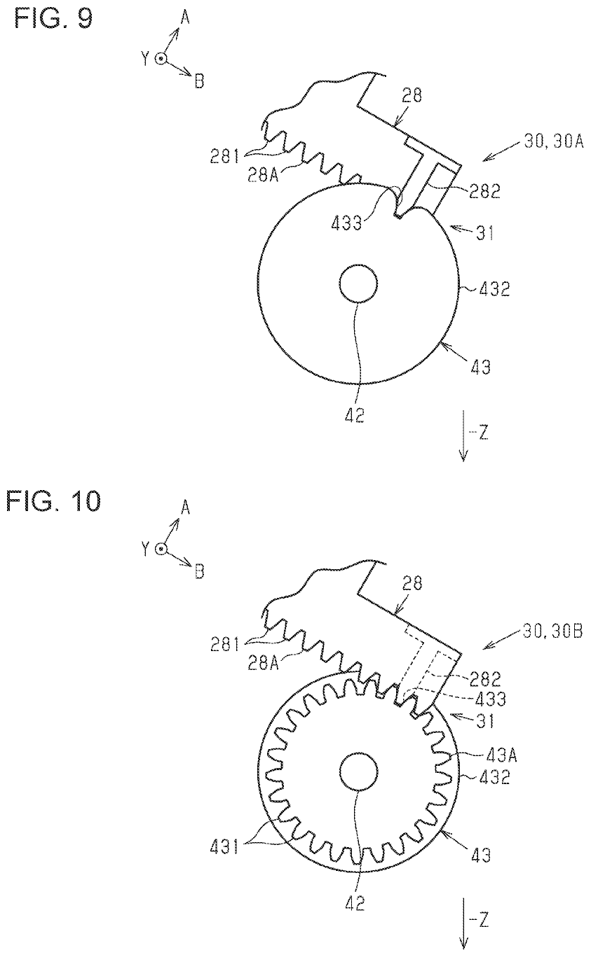

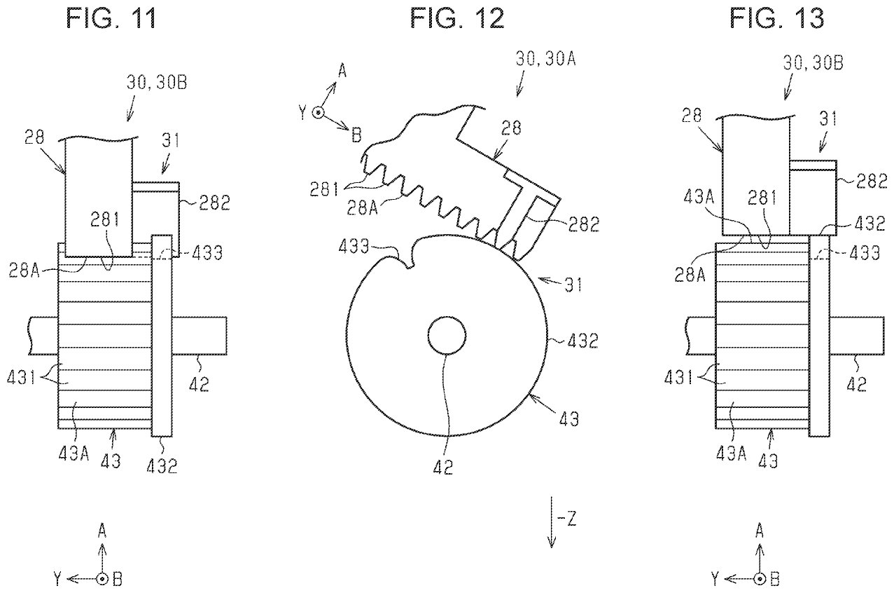

Next, the switching mechanism 31 provided in the rack and pinion mechanism 30 related to the head 20H will be described with reference to FIGS. 9 to 13. FIGS. 9 to 11 illustrate a state where the rack and pinion mechanism 30 is meshed, and FIGS. 12 and 13 illustrate a non-meshing state before the rack and pinion mechanism 30 is meshed.

As illustrated in FIGS. 9 to 13, the switching mechanism 31 of the present example includes a plug-in key 282 provided in the rack 28 and a groove 433 provided in the drive gear 43 and capable of meshing with the plug-in key 282. When the head unit 20 is attached to the apparatus main body, the meshing between the plug-in key 282 and the groove 433 of the switching mechanism 31 is performed before the meshing between the rack 28 and the drive gear 43. When the plug-in key 282 and the groove 433 of the switching mechanism 31 mesh with each other, a relative distance between the rack 28 and the drive gear 43 is narrowed, so that the rack 28 and the drive gear 43 can mesh with each other. When the plug-in key 282 and the groove 433 of the switching mechanism 31 do not mesh with each other, the relative distance between the rack 28 and the drive gear 43 cannot be narrowed, so that the rack 28 and the drive gear 43 do not mesh with each other. Since the plug-in key 282 meshes with the groove 433, it can be regarded as one tooth. In the present embodiment, the plug-in key 282 constitutes an example of the tooth included in the switching mechanism 31 and the tooth of the groove. Further, assuming that the tooth of the rack and pinion mechanism 30 is the first tooth and the tooth of the switching mechanism 31 is the second tooth, the tooth 281 of the rack 28 and the tooth 431 of the drive gear 43 correspond to an example of the first tooth. Further, the plug-in key 282 of the switching mechanism 31 corresponds to an example of the second tooth.

As illustrated in FIGS. 9 to 13, the pair of rack and pinion mechanisms 30 (30A and 30B) are provided with the switching mechanism 31 for switching the presence and absence of the meshing between the rack 28 and the drive gear 43. The switching mechanism 31 has a function of switching from the non-meshing state to the meshing state at a predetermined phase position so that the meshing phase of the rack 28 and the drive gear 43 is matched between the pair of rack and pinion mechanisms 30A and 30B.

As illustrated in FIGS. 9 to 13, the switching mechanism 31 is configured of the plug-in key 282 formed in the rack 28, a flange portion 432 formed in the drive gear 43, and the groove 433 recessed so as to be meshed with the plug-in key 282 with respect to an outer peripheral surface of the flange portion 432.

The plug-in key 282 of the switching mechanism 31 is provided at a position different from the tooth portions 28A and 43A of the rack and pinion mechanism 30 in an axial direction of the drive gear 43. That is, the switching mechanism 31 is provided at a shifted position in the axial direction of the drive gear 43 adjacent to the forming locations of the tooth portions 28A and 43A where the rack 28 and the drive gear 43 can mesh with each other. Specifically, the plug-in key 282 protrudes on the side surface of the rack at a position different from the tooth portion 28A in the axial direction of the drive gear 43. Further, the drive gear 43 is formed of the flange portion 432 at a position different from the tooth portion 43A in the axial direction of the drive gear 43 and the groove 433 recessed at a position capable of meshing with the plug-in key 282 on the outer peripheral surface of the flange portion 432.

The switching mechanism 31 has a first portion on the drive gear 43 side and a second portion on the rack 28 side.

The first portion has a cylindrical flange that is concentric with the tooth portion of the drive gear 43 and has an outer diameter larger than an outer diameter of the tooth portion, and a groove that is formed in the flange.

The phase of the plug-in key 282 of the switching mechanism 31 and the phase of the tooth portions 28A and 43A of the rack and pinion mechanism 30 are the same. The tooth portion 28A of the rack 28 is configured of a plurality of first teeth 281 arranged at a constant pitch in the B direction. Further, the tooth portion 43A of the drive gear 43 is configured of a plurality of first teeth 431 arranged at a constant pitch in a circumferential direction. A shape of the tooth portion 28A has a phase in which a peak portion of a portion of the first tooth 281 and a valley portion recessed at a portion between the first teeth 281 are alternately arranged. The plug-in key 282, which is an example of the second tooth of the switching mechanism 31, is formed at the position of the first tooth 281.

One of the plug-in key 282 and the groove 433 of the switching mechanism 31 is provided at a position meshing with the tooth portion 28A of the pair of racks 28 in the same phase. That is, the second tooth portion is formed at a position corresponding to an Nth tooth of the plurality of first teeth formed on the rack 28 from the end portion on the +A direction side. That is, the plug-in key 282 of the switching mechanism 31 is formed in the pair of racks at a position having the same phase in the tooth portion 28A. In the examples of FIGS. 9 and 12, the Nth is the second.

The drive gear 43 and the rack 28 have first teeth 431 and 281. The switching mechanism 31 has the plug-in key 282 as an example of the second tooth having meshing longer than those of the first teeth 431 and 281. According to the plug-in key 282, a meshing depth with the groove 433 is longer than a meshing depth by the first teeth 431 and 281, and the meshing thereof is performed at a switching position.

The drive gear 43 is rotated in the direction in which the head unit 20 moves in the gravity direction −Z, so that the switching mechanism 31 meshes therewith. Here, the gravity direction −Z is a direction in which the head unit 20 has a component in the moving direction in the vertical direction Z, which is the gravity direction, and can be moved by the self-weight due to the gravity. The moving direction is inclined with respect to the horizontal and the gravity direction −Z refers to the downward direction of the inclined moving direction. An inclination angle in the moving direction with respect to the horizontal is not limited to an acute angle and may be 90 degrees.

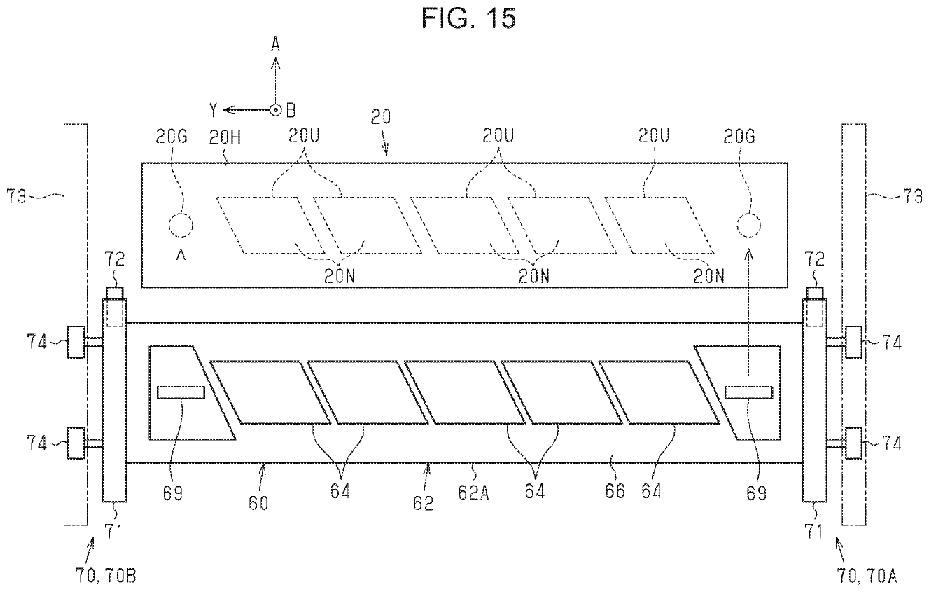

Next, a detailed configuration of the cap unit 62 will be described with reference to FIGS. 14 and 15. As illustrated in FIGS. 14 and 15, a pair of positioning pins 20G protrude in the head unit 20 at positions on both sides thereof sandwiching a plurality of heads 20H therebetween in the Y direction. The pair of pins 20G protrude in the B direction to a position lower than the nozzle surface 20N of the head 20H.

Here, a configuration of the cap unit 62 will be described with reference to FIG. 14.

The printer 1 includes the cap unit 62. The cap unit 62 includes the cap 64, a cap holder 66 for holding the cap 64, and a first spring 65 provided between the cap 64 and the cap holder 66. The first spring 65 urges the cap 64 in the −B direction. In the present embodiment, the head 20H is configured by arranging a plurality of unit heads 20U illustrated in FIG. 8 in the Y direction. The cap unit 62 illustrated in FIG. 14 includes a plurality of caps 64 arranged in the width direction Y at positions facing the plurality of unit heads 20U. The cap 64 is open on the −B direction side facing the head 20H and has a seal portion (not illustrated) made of a rubber elastic material provided around the opening. When the head 20H is pressed against the cap 64, at least a part of the seal portion is elastically compressed. The head 20H presses the cap 64 with a predetermined cap pressure with an urging force of the first spring 65 in the −B direction (lifting direction), an urging force of the second spring 29 in the +B direction (lowering direction), and a restoring force of the elastically compressed seal portion.

A size and a shape of the cap 64 are set to a size and a shape for covering the nozzle surface 20N of the unit head 20U constituting the head 20H. Further, the cap 64 is disposed so as to face the nozzle surface 20N in the B direction. The cap 64 covers a plurality of nozzles N which are open in the nozzle surface 20N by being in contact with the nozzle surface 20N of the head 20H with a predetermined cap pressure. By covering the nozzle surface 20N with the cap 64, an increase in viscosity by drying of the liquid such as ink within the nozzle N of the head 20H is suppressed. When the head unit 20 moves from the retracted position (see FIG. 27) to a predetermined cap position PH2 in the B direction that is the lowering direction, the head 20H is pressed against the cap 64 in a state where the nozzle N is covered and is in the capping state.

The cap 64 is attached to the cap holder 66 in a state of being relatively movable in the lifting and lowering directions ±B via the slide portion 67. The slide portion 67 is configured in a state where a first slide portion extending from the upper surface of the cap holder 66 in the −B direction and a second slide portion (both not illustrated) extending from the bottom surface of the cap 64 in the +B direction are coupled to be relatively displaceable. The first spring 65 is interposed between the bottom surface of the cap 64 and the upper surface of the cap holder 66. The first spring 65 is, for example, a compression spring. The cap 64 is urged by an elastic force of the first spring 65 in the direction-B direction that is the lifting direction with respect to the cap holder 66. The first spring 65 may be an elastic member such as a tension spring or a torsion coil spring as long as the cap 64 can be urged in the −B direction.

The cap holder 66 is supported on the housing 62A of the cap unit 62. The housing 62A is formed in a box shape that is long in the Y direction and short in the A direction. The housing 62A is formed of a square box-shaped casing that is open on the −B direction side. A plurality of caps 64 are exposed from the opening of the housing 62A.

The printer 1 includes the rack and pinion mechanisms 70 as the moving mechanism that moves the cap unit 62 illustrated in FIG. 14 in the A direction. A pair of racks 71 constituting the rack and pinion mechanisms 70 are fixed to side surfaces of the housing 62A on both sides in the Y direction. A pair of drive gears 72 constituting the rack and pinion mechanisms 70 are disposed in a rotatable state below facing tooth portions 71A of a pair of racks 71. The tooth portion 71A of the rack 71 meshes with the tooth portion 72A of the drive gear 72. The pair of drive gears 72 are attached to both end portions of the shaft (rotation shaft) 75. Further, on the side walls of the cap unit 62 on both sides in the width direction Y, the guide roller 74 formed of a plurality of rollers that can rotate in the width direction Y that is the axial direction is provided. The guide roller 74 is guided along the guide rail 73 (FIG. 6) with a C-shaped cross section.

When the shaft 75 is rotated by the power of the motor 81 (FIG. 2) that is the drive source of the cap unit 62, the pair of drive gears 72 are rotated. When the motor 81 is forward driven, the cap unit 62 moves in the +A direction via the meshing between the drive gear 72 and the rack 71. On the other hand, when the motor 81 is reversely driven, the cap unit 62 moves in the −A direction via the meshing between the drive gear 72 and the rack 71.

Further, as illustrated in FIGS. 14 and 15, a pair of engaged portions 69 for positioning protrude in the cap unit 62 at positions on both sides thereof sandwiching the plurality of caps 64 therebetween in the width direction Y. The pair of engaged portions 69 protrude to a position higher than the upper surface of the cap 64 in the −B direction. In the process of moving the cap unit 62 from the standby position PC1 to the capping position PC2, the engaged portion 69 engages with the pin 20G on the head unit 20 side, so that the cap unit 62 is positioned at the capping position PC2 (FIG. 3) in the A direction.

Next, with reference to FIG. 16, the guide rails 37 to 39 for guiding the head unit 20 and the guide rail 73 for guiding the cap unit 62 will be described in detail.

As illustrated in FIG. 16, insertion openings 38A and 39A for inserting the guide roller 25 are formed at the open ends of the induction guide rails 38 and 39. At least one of the insertion openings 38A and 39A is widened in a shape expanding toward the opening end side. An interval in the X direction and an interval in the B direction between the two guide rails 38 and 39 are adjusted to the interval between the two guide rollers 25 of the head unit 20 in the B direction when being in the inclination posture in the B direction illustrated by a two-dot chain line in FIG. 16. Therefore, if the head unit 20 is input along the guide rails 38 and 39, the head unit 20 when reaching the exchange position PH4 is disposed in the inclination posture in the B direction as illustrated in FIG. 16. In this posture, the rack 28 is placed on the drive gear 43 (see FIG. 3) in a state of being urged in the gravity direction −Z by the weight of the head unit 20.

Further, the two guide rails 38 and 39 are coupled to the guide rail 37 so that both the two guide rollers 25 can move. When the head unit 20 is input to the exchange position PH4, the two guide rollers 25 are configured to be movable at least toward the transport unit 10. Since a wiper unit (not illustrated) moves in the width direction, the guide rail 37 is divided into two at a portion corresponding to the movement path of the cap unit 62 and the wiper unit in order to secure the movement path thereof. The guide rail 37A of the divided parts on the +B direction side is coupled to the guide rail 37. The outer diameter of the guide roller 25 is larger than the outer diameter of the guide roller 74. Therefore, the width of the guide rails 37 and 37A is larger than the width of the guide rail 73. Therefore, even if the guide roller 25 moves to the guide rail 37A, the movement of the guide roller 25 to the guide rail 73 is regulated. The guide rail 37 illustrated in FIG. 16 and the other guide rail 37 disposed on the opposite side in the width direction Y are not divided.

Further, an insertion opening 73A is open at the upper end of the guide rail 73. The cap unit 62 is attached and detached to and from the guide rail 73 by attaching and detaching the guide roller 74 to and from the insertion opening 73A. The guide rail 73 is disposed at a position that does not hinder the movement path of the wiper unit.

As illustrated in FIG. 17, when the cap 64 is exchanged, the cap unit 62 is disposed at the first exchange position PC3 illustrated in the same drawing. Since it is not necessary to remove the cap unit 62 when exchanging the cap, the rack and pinion mechanism 70 is in the meshed state.

As illustrated in FIG. 18, when the cap unit 62 is exchanged, the cap unit 62 is disposed at the second exchange position PC4 illustrated in the same drawing. The second exchange position PC4 is located on the +A direction side, that is, on the removal direction side with respect to the first exchange position PC3 (FIG. 17). When the cap unit 62 is exchanged, it is necessary to remove the cap unit 62, so that the rack and pinion mechanism 70 is in the non-meshing state.

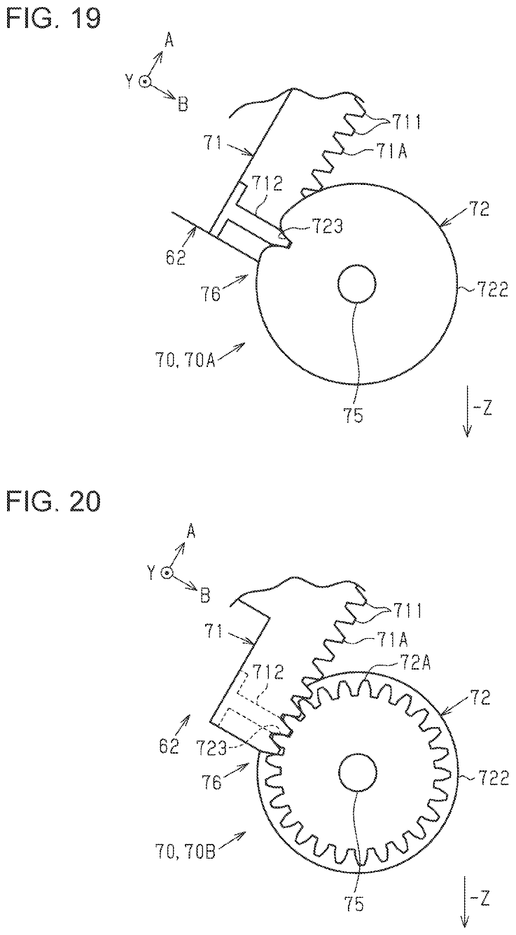

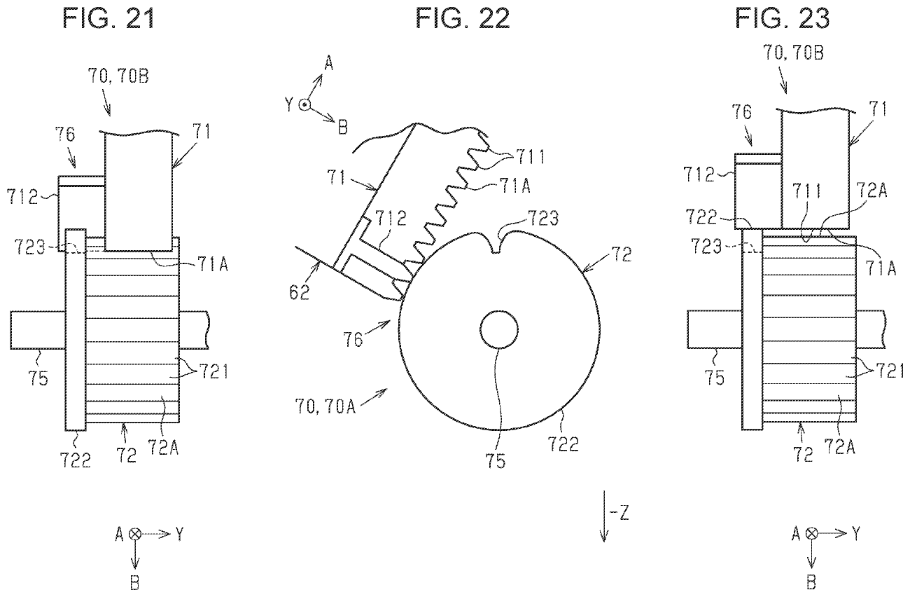

Next, the switching mechanism 76 provided in the rack and pinion mechanism 70 related to the cap 64 will be described with reference to FIGS. 19 to 23. FIGS. 19 to 21 illustrate a state where the rack and pinion mechanism 70 is meshed, and FIGS. 22 and 23 illustrate a non-meshing state before the rack and pinion mechanism 70 is meshed.

As illustrated in FIGS. 19 to 23, the switching mechanism 76 of the present example includes a plug-in key 712 that is an example of the second tooth provided in the rack 71, and a groove 723 that is provided in the drive gear 72 and is capable of meshing with the plug-in key 712. When the cap unit 62 is attached to the apparatus main body, the meshing between the plug-in key 712 and the groove 723 of the switching mechanism 76 is performed before the meshing between the rack 71 and the drive gear 72. When the plug-in key 712 and the groove 723 of the switching mechanism 76 mesh with each other, a relative distance between the rack 71 and the drive gear 72 is narrowed, so that the rack and the drive gear 72 71 can mesh with each other. When the plug-in key 712 and the groove 723 of the switching mechanism 76 do not mesh with each other, the relative distance between the rack 71 and the drive gear 72 cannot be narrowed, so that the rack 71 and the drive gear 72 do not mesh with each other. Since the plug-in key 712 meshes with the groove 723, it can be regarded as one tooth. In the present embodiment, the plug-in key 712 constitutes an example of the tooth included in the switching mechanism 76 and the tooth of the groove. Further, assuming that the tooth of the rack and pinion mechanism 70 is the first tooth and the tooth of the switching mechanism 76 is the second tooth, the tooth 711 of the rack 71 and the tooth 721 of the drive gear 72 correspond to an example of the first tooth. Further, the plug-in key 712 of the switching mechanism 76 corresponds to an example of the second tooth.

As illustrated in FIGS. 19 to 23, the pair of rack and pinion mechanisms 70 (70A and 70B) are provided with the switching mechanism 76 for switching the presence and absence of the meshing between the rack 71 and the drive gear 72. The switching mechanism 76 has a function of switching from the non-meshing state to the meshing state at a predetermined phase position so that the meshing phase of the rack 71 and the drive gear 72 is matched between the pair of rack and pinion mechanisms 70A and 70B.

As illustrated in FIGS. 19 to 23, the switching mechanism 76 is configured of the plug-in key 712 formed in the rack 71, the flange portion 722 formed in the drive gear 72, and the groove 723 recessed so as to mesh with the plug-in key 712 with respect to the outer peripheral surface of the flange portion 722.

The plug-in key 712 of the switching mechanism 76 is provided at a position different from the tooth portions 71A and 72A of the rack and pinion mechanism 70 in the axial direction of the drive gear 72. That is, the switching mechanism 76 is provided at a shifted position in the axial direction of the drive gear 72 adjacent to a forming location of the tooth portions 71A and 72A where the rack 71 can mesh with the drive gear 72. Specifically, the plug-in key 712 protrudes on the side surface of the rack 71 at a position different from the tooth portion 71A in the axial direction of the drive gear 72. Further, the drive gear 72 is formed of the flange portion 722 at a position different from the tooth portion 72A in the axial direction of the drive gear 72 and the groove 723 recessed at a position capable of meshing with the plug-in key 712 on the outer peripheral surface of the flange portion 722.

The switching mechanism 76 has the first portion on the drive gear 72 side and the second portion on the rack 71 side. The first portion has a cylindrical flange portion 722 that is concentric with the tooth portion 72A of the drive gear 72 and has an outer diameter larger than an outer diameter of the tooth portion 72A, and the groove 723 that is formed in the flange portion 722.

The phase in which the plug-in key 712 and the groove 723 of the switching mechanism 76 are located is the same as the phase of the tooth portions 71A and 72A of the rack and pinion mechanism 70. The tooth portion 71A of the rack 71 is configured of a plurality of first teeth 711 arranged at a constant pitch in the B direction. Further, the tooth portion 72A of the drive gear 72 is configured of a plurality of first teeth 721 arranged at a constant pitch in the circumferential direction. The shape of the tooth portion 71A has a phase in which the peak portion of the portion of the first tooth 711 and the valley portion recessed at the portion between the first teeth 711 are alternately arranged. The plug-in key 712 of the switching mechanism 76 is formed at the position of the first tooth 711.

One of the plug-in key 712 and the groove 723 of the switching mechanism 76 is provided at a position meshing with the tooth portion 71A of the pair of racks 71 in the same phase. That is, the plug-in key 712 is formed at a position corresponding to the Nth tooth of the plurality of first teeth 711 formed on the rack 71 from the end portion on the +A direction side. That is, the pair of racks 71 are formed with the plug-in key 712 of the switching mechanism 76 at the positions having the same phase in the tooth portion 71A. In the examples of FIGS. 19 and 22, the Nth is the second.

The drive gear 72 and the rack 71 have the first teeth 721 and 711. The switching mechanism 76 has the plug-in key 712 as an example of the second tooth having the meshing longer than the first teeth 721 and 711. The depth of the meshing with the groove 723 by the plug-in key 712 is longer than the meshing depth by the first teeth 721 and 711, and the meshing is performed at the switching position.

The switching mechanism 76 meshes with the drive gear 72 by being rotated in the direction in which the cap unit 62 moves in the gravity direction −Z. Here, the gravity direction −Z is a direction in which the cap unit 62 has a component in the moving direction in the vertical direction Z, which is the gravity direction, and the cap unit 62 can move by the self-weight due to gravity. The moving direction is inclined with respect to the horizontal and the gravity direction −Z refers to the downward direction of the inclined moving direction. An inclination angle in the moving direction with respect to the horizontal is not limited to an acute angle and may be 90 degrees.

Next, an electrical configuration of the printer 1 will be described. The printer 1 receives recording data from, for example, a host device (not illustrated). The recording data includes recording condition information and image data of, for example, a CMYK color system that defines a recording content. The recording condition information includes information such as a medium size, a medium type, presence and absence of double-sided recording, a recording color, and recording quality. The control section 26 within the printer 1 is electrically coupled to the head 20H, the transport roller pair 11, the transport belt 15, and the like. Further, the control section 26 is electrically coupled to the motor 41 that is a drive source for moving the head unit 20 in the lifting and lowering directions ±B, the motor 49 that is a drive source for rotating the eccentric cam 48, the motor 81 that is a drive source for moving the cap unit 62 in the ±A directions, and a pump motor (not illustrated) that is a drive source of a pump coupled to the cap 64.

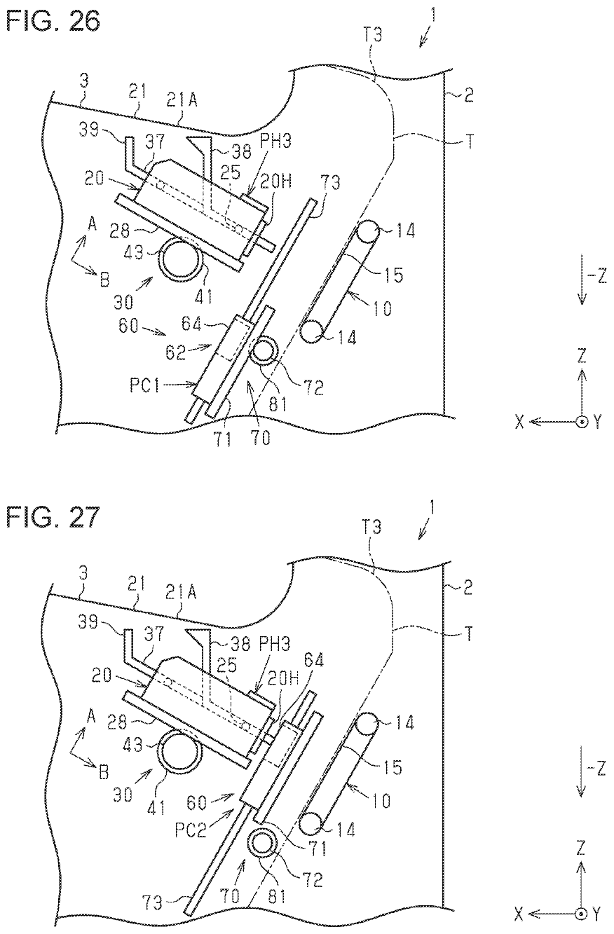

The control section 26 controls the head 20H, the transport roller pair 11, the transport belt 15, and the like. Further, the control section 26 controls the motor 41 to move the head unit 20 in the lifting and lowering directions ±B. The control section 26 moves the head unit 20 to the retracted position (FIG. 26), the recording position (FIG. 2), and the exchange position. The exchange position is a position where the operator removes the head unit 20 from the printer 1 when the head unit 20 is exchanged due to a failure or the like. The ±A directions are directions that intersects (for example, orthogonal) with the lifting and lowering directions ±B, and are directions in which the cap unit 62 having the cap 64 moves, thereby being also referred to as cap moving directions ±A.

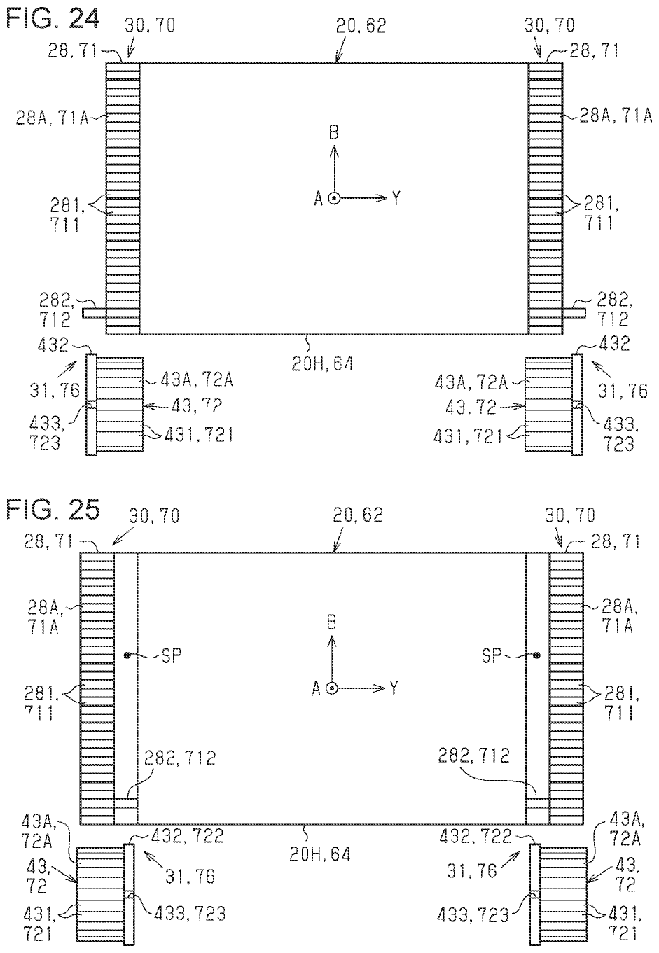

Next, with reference to FIGS. 24 and 25, a configuration of the head unit 20 or the cap unit 62 (FIG. 24) including the rack and pinion mechanism 30 (70) and the switching mechanism 31 (76) of the example, and a configuration of a head unit 20 or a cap unit 62 (FIG. 25) including a rack and pinion mechanism and a switching mechanism of a comparative example are compared. Since the differences between the example and the comparative example are the same in the head unit 20 and the cap unit 62, the head unit 20 will be described below, and the cap unit 62 will be omitted.

As illustrated in FIG. 24, the rack and pinion mechanism 30 has the tooth portion 28A formed on the rack 28 and the tooth portion 43A formed on the drive gear 43 as tooth portions that mesh with each other. In the width direction Y of the head unit 20, the tooth portions 28A and 43A of the rack and pinion mechanism 30 are located on the head unit 20 side with respect to the plug-in key 282 of the switching mechanism 31. Therefore, the first teeth 281 and 431, and the head unit 20 can be brought close to each other in the axial direction of the drive gear 43. The plug-in key 282, which is an example of the second tooth, is located outside the drive gear 43 in the axial direction (that is, the width direction Y). Therefore, a space occupied by the head unit 20 by lifting and lowering can be reduced, so that the product can be easily miniaturized in the width direction Y.

On the other hand, in the comparative example illustrated in FIG. 25, in the width direction Y of the head unit 20, the tooth portions 28A and 43A of the rack and pinion mechanism 30 are located on a side opposite to the head unit 20 side with respect to the plug-in key 282 of the switching mechanism 31. Therefore, a wasted space SP is generated between the first teeth 281 and 431, and the head unit 20 in the axial direction of the drive gear 43. This space SP increases the space occupied by the lifting and lowering of the head unit 20, which leads to an increase in the size of the product in the width direction Y.

Next, an operation of the printer 1 which is an example of the liquid ejecting apparatus will be described.

The user designates an image or the like of a recording target and sets an input of recording condition information by operating a pointing device such as a keyboard or a mouse (all not illustrated) of a host device (not illustrated). The recording condition information includes the medium size, the medium type, the recording color, the number of recorded sheets, and the like. The host device transmits a recording job including the recording condition information and the image data to the printer 1.

The printer 1 receives the recording job from the host device. The control section 26 drives the pick roller 6, the roller pairs 7, 8, and 11, and the transport unit 10 based on the recording condition information included in the recording job. As a result, the printer 1 feeds the medium P of the designated medium type and medium size from the cassette 4. The fed medium P is transported on the transport belt 15 through the transport path T. Further, the control section 26 controls the head 20H based on the image data included in the recording job. The head 20H ejects the liquid such as ink toward the medium P transported on the transport belt 15. The recorded medium P is discharged to the discharge tray 21.

The control section 26 moves the head unit 20 from the cap position to the retracted position. Next, the cap unit 62 is moved from the capping position to the retracted position. Prior to starting the recording, the control section 26 adjusts the gap between the head 20H and the transport belt 15 based on the information of the medium type. The control section 26 drives the motor 49 to rotate the eccentric cam 48 at a rotation angle according to the gap determined by the medium type.

As illustrated in FIG. 15, at the time of the recording, the head unit 20 lowers from the retracted position and the plate portion 20A abuts against the eccentric cam 48, so that the head 20H is positioned at the recording position. The control section 26 forward drives the motor 41 and lowers the head unit 20 from the retracted position until the plate portion 20A abuts against the cam surface 48A of the eccentric cam 48 as illustrated in FIG. 15.

As illustrated in FIG. 16, the head unit 20 is positioned at the recording position where the plate portion 20A abuts against the eccentric cam 48. At this recording position, the head 20H ejects the liquid from the nozzle N toward the medium P which is transported by the transport belt 15. At this time, since the gap between the head 20H and the transport belt 15 is adjusted at an appropriate value, the recording on the medium P is performed with good recording quality.

When the recording is completed, the head 20H is in the capping state (FIG. 28) where the nozzle N is covered with the cap 64. First, the head unit 20 retracts from the recording position (FIG. 2) to the retracted position (FIG. 26). This movement is performed by the control section 26 reversely driving the motor 41. Next, the control section 26 moves the cap unit 62 from the standby position (FIG. 26) to the capping position (FIG. 27). This movement is performed by the control section 26 forward driving the motor 81. Next, the control section 26 moves the head unit 20 from the retracted position (FIG. 27) to the cap position (FIG. 28). This movement in the capping process is performed by the control section 26 forward driving the motor 41. In the capping state, the head 20H is pressed against the cap 64 with an appropriate cap pressure. Under this capping state, drying of the liquid such as ink within the nozzle N is effectively suppressed.

Further, at the time of the cleaning, since a closed space surrounded by the nozzle surface 20N and the cap 64 is depressurized to a required negative pressure in the capping state, cleaning for forcibly discharging the liquid from the nozzle N is appropriately performed. The cleaning is not limited to the configuration in which the inside of the cap 64 is depressurized and, for example, the liquid within the liquid accommodation section 23 (see FIG. 1) is pressurized upstream of the nozzle N to forcibly discharge the liquid from the nozzle N.

In addition, the control section 26 manages the flushing timing during the recording. When the flushing timing is reached during the recording, the control section 26 allows the head 20H to perform the flushing. When the recording on the medium P which was recorded is completed when the flushing timing is reached, the subsequent transport of the medium P is temporarily stopped. First, the head unit 20 is moved from the recording position illustrated in FIG. 2 to the retracted position PH3 illustrated in FIG. 26. Next, the cap unit 62 is moved from the standby position PC1 to the capping position PC2 in the +A direction. This capping position PC2 is also the flushing position. Further, a position where the head unit 20 is slightly lowered from the retracted position PH3 may be the flushing position. The head 20H ejects the liquid from the nozzle N toward the cap 64. As a result, the thickening ink, air bubbles, and the like within the nozzle N are discharged together with the liquid such as the ink, and the clogging of the nozzle N is eliminated or prevented. Therefore, the head 20H records on the medium P with high recording quality.

Next, a case where the head unit 20 is exchanged will be described.

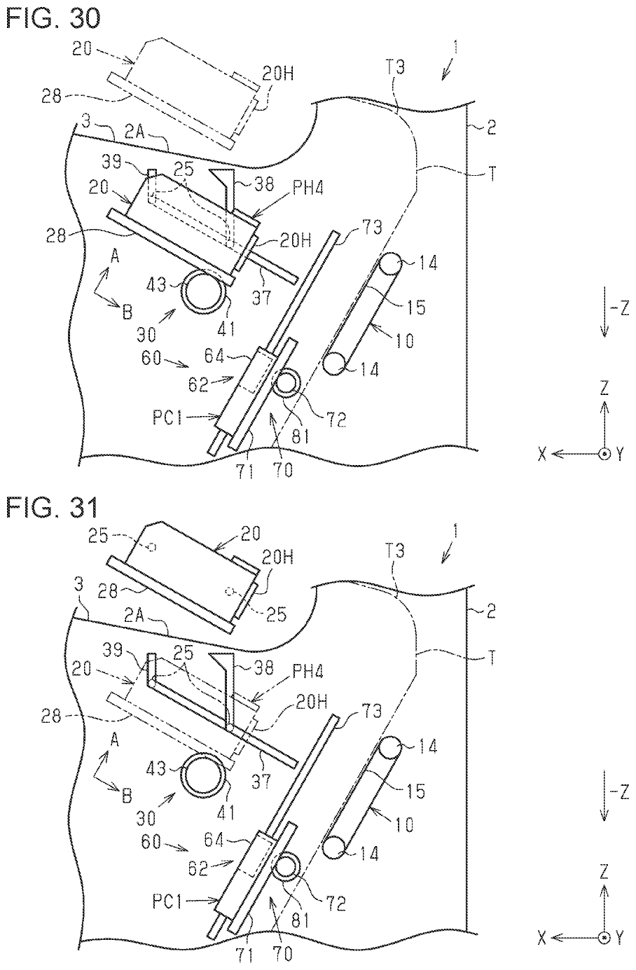

By removing the discharge tray 21 of the housing 2, the input opening 2A formed of the opening of the housing 2 is exposed. When the head unit 20 is exchanged, the drive gear 43 is rotated by the drive of the motor 41 and the rack 28 that meshes with the drive gear 43 moves in the −B direction, so that the head unit 20 fixed to the rack 28 moves to the exchange position PH4 (FIGS. 3 and 29). The operator pulls up the head unit 20 at the exchange position PH4 in the vertical direction Z along the two guide rails 38 and 39 and takes the head unit 20 out from the input opening 2A as illustrated by a two-dot chain line in FIG. 30.

Next, the new head unit 20 is attached to the apparatus main body. The operator inputs the head unit 20 illustrated by the solid line in FIG. 31 from the input opening 2A. At this time, the guide roller 25 is inserted into the insertion openings 38A and 39A of the guide rails 38 and 39, and the head unit 20 is input in the gravity direction −Z along the guide rails 38 and 39. The head unit 20 is disposed at the exchange position PH4 illustrated by a two-dot chain line in FIG. 31.

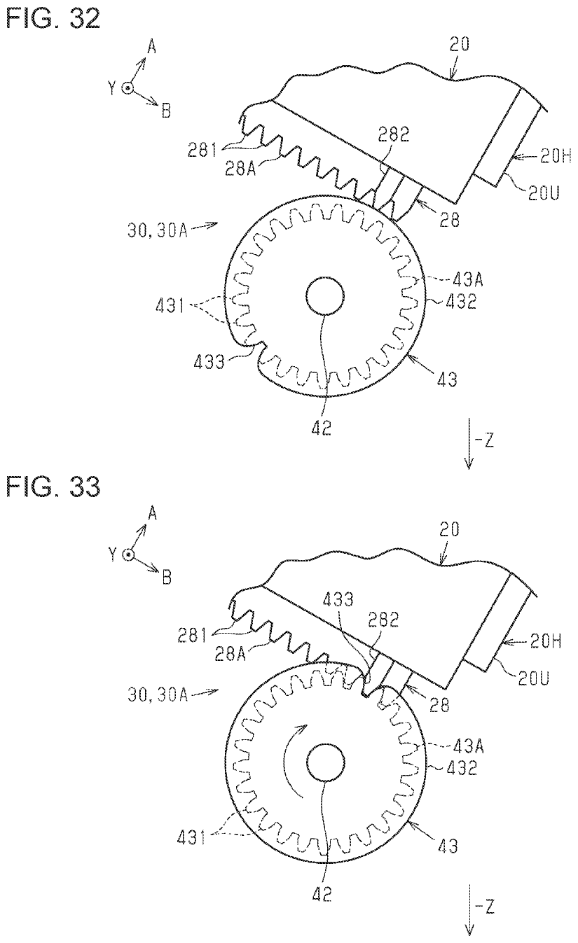

When the head unit 20 is disposed at the exchange position PH4, as illustrated in FIG. 32, the tooth portion 28A of the rack 28 is placed on the flange portion 432 of the drive gear 43. Therefore, the rack and pinion mechanism 30 does not mesh. When the motor 41 is forward driven, the drive gear 43 rotates in the clockwise direction indicated by an arrow in FIG. 33. Then, the plug-in key 282 meshes with the groove 433. As a result, the tooth portion of the rack 28 and the tooth portion 43A of the drive gear 43 mesh with each other. That is, the rack and pinion mechanism 30 is in the meshed state. When the rack and pinion mechanism 30 meshes in this way, the head unit 20 lowers to a predetermined position and stops together with the rack 28.

Next, a case where the cap unit 62 is exchanged will be described.

By removing the cover member (not illustrated) of the housing 2, the input opening formed of the opening of the housing 2 is exposed. When exchanging the cap unit 62, the drive gear 72 is rotated by the drive of the motor 81, and the rack 71 that meshes with the drive gear 72 moves in the +A direction, so that the cap unit 62 fixed to the rack 71 moves to the second exchange position PC4. The cap unit 62 is removed from the apparatus main body by removing the guide roller 74 from the insertion opening 73A at the end of the guide rail 73 in the +A direction.

Next, the new cap unit 62 is attached to the apparatus main body. The operator inputs the cap unit 62 from the input opening (not illustrated). At this time, the guide roller 74 is inserted into the insertion opening 73A of the guide rail 73, and the input is performed along the guide rail 73. The cap unit 62 lowers along the guide rail 73 by self-weight and the tooth portion 71A of the rack 71 is placed on the flange portion on the drive gear 72 side (FIGS. 22 and 23). Therefore, the rack and pinion mechanism 70 does not mesh. When the motor 81 is reversely driven, the drive gear 72 rotates in the counterclockwise direction in FIG. 22. Then, the plug-in key 712 meshes with the groove 723. As a result, the tooth portions 71A of the rack 71 and the tooth portions 72A of the drive gear 72 mesh with each other. That is, the rack and pinion mechanism 70 is in the meshed state. When the rack and pinion mechanism 70 meshes in this way, the cap unit 62 lowers to a predetermined position and stops together with the rack 71.

Further, when the cap is exchanged, the cap unit 62 moves to the first exchange position PC3 by the drive of the motor 81. The attachment and detachment direction of the cap 64 with respect to the cap unit 62 at the first exchange position PC3 is the A direction. The operator removes the cap 64 from the cap unit 62 and attaches the new cap 64 to the cap unit 62.

### Manufacturing Method

The printer 1 includes the head unit 20, a pair of rack and pinion mechanisms 30 that move the head unit 20 in the B direction, which is the first direction in which the rack 28 extends, the switching mechanism 31 that is provided for each rack and pinion mechanism 30 and switches the presence and absence of the meshing between the rack 28 and the drive gear 43 when the head unit 20 is at the exchange position PH4.

The manufacturing method of the printer 1 includes an inputting step and a meshing step. The inputting step is a step of placing the head unit 20 in a state where the rack 28 faces the drive gear 43. In the meshing step, the drive gear 43 is rotated to mesh the switching mechanism 31, so that the pair of rack and pinion mechanisms 30 are meshed in the same phase.

Hereinafter, the manufacturing method of the printer 1 will be specifically described with reference to FIGS. 26 to 31 and the like. At the time of manufacturing, the head unit 20 is assembled at a predetermined position within the housing 2.

As illustrated in FIG. 30, the operator inputs the head unit 20 indicated by the two-dot chain line from the input opening 2A. At this time, the operator inputs the guide roller 25 along the guide rails 38 and 39 in the Z direction while inserting the guide roller 25 from the upper end portions of the guide rails 38 and 39. The input head unit 20 moves to the exchange position PH4 when the guide roller 25 is guided by the guide rails 38 and 39 and moves in the −Z direction.

As a result, the head unit 20 is input to the exchange position PH4 illustrated by the solid line in FIG. 30. In this input state, the rack 28 of the head unit 20 is in a state of being placed on the drive gear 43, and the tooth portion 28A of the rack 28 and the tooth portion 43A of the drive gear 43 are not yet meshed (FIG. 32). Specifically, the plug-in key 282 provided in the rack 28 is in a state of being placed on the outer peripheral surface of the flange portion 432 of the drive gear 43. In this state, since the distance between the rack 28 and the drive gear 43 is larger than the position at the time of meshing, the rack and pinion mechanism 30 does not mesh. In this state, the control section 26 forward drives the motor 41 to rotate the drive gear 43 in the direction in which the head unit 20 lowers. When the drive gear 43 is rotated in the clockwise direction indicated by the arrow in FIG. 33, the groove 433 of the switching mechanism 31 moves in the circumferential direction with the rotation of the drive gear 43. When the groove 433 moves to a position facing the plug-in key 282, the plug-in key 282 falls into the groove 433 due to the weight of the head unit 20. As a result, a relative distance between the rack 28 and the drive gear 43 is narrowed, so that the rack and the drive gear 43 mesh with each other.

After that, the drive of the motor 41 is continued and the head unit 20 lowers to a predetermined position in the +B direction and stops.

In the related art, the operator manually inputs the head unit 20 and places the rack in the drive gear to allow the tooth portion of the rack to mesh with the tooth portion of the drive gear. Therefore, if the posture of the head unit 20 is inclined when the rack 28 is placed in the drive gear 43, the pair of rack and pinion mechanisms 30 are out of phase and mesh with each other on both sides in the width direction Y.

On the other hand, in the present embodiment, since the phase when the plug-in key 282 meshes with the groove is predetermined, the drive gear 43 is rotated after the input of the head unit 20 to allow the plug-in key 282 to mesh with the groove 433. Therefore, the movement of the pair of rack and pinion mechanisms can be matched on both sides in the width direction Y. Therefore, the phase shift of the pair of rack and pinion mechanisms 30 is prevented.

When the plug-in key 282 and the groove 433 of the switching mechanism 31 do not mesh with each other, the relative distance between the rack 28 and the drive gear 43 cannot be narrowed, so that the rack 28 and the drive gear 43 do not mesh with each other.

Further, even when assembling the cap unit 62 to the apparatus main body at the time of manufacturing, the same as the attachment at the time of exchanging the cap unit 62 is performed. Therefore, the cap unit 62 can be assembled in a state where the phases of the pair of rack and pinion mechanisms 70 are matched.

As described in detail above, according to the present embodiment, the following effects can be obtained.

1. The printer 1 as an example of the liquid ejecting apparatus includes the head unit 20 as an example of the movable body including the head 20H for ejecting the liquid, or the cap unit 62 as an example of the movable body including the cap 64 for performing the maintenance of the head 20H. Further, the printer 1 includes the racks 28 and 71, and the drive gears 43 and 72, and includes the pair of rack and pinion mechanisms 30 and 70 that move the head unit 20 or the cap unit 62 in the first direction in which the racks 28 and 71 extend. Further, the printer 1 includes the switching mechanisms 31 and 76 that are provided for each of the rack and pinion mechanisms 30 and 70, and switches the presence and absence of the meshing between the racks 28 and 71, and the drive gears 43 and 72 when the head unit 20 or the cap unit 62 is at the exchange positions PH4 and PC4. Therefore, since there are switching mechanisms 31 and 76 for each of the rack and pinion mechanisms 30 and 70, when the head unit 20 or the cap unit 62 is attached to the apparatus main body for exchange or the like at the exchange positions PH4 and PC4, the drive gears 43 and 72 can mesh with the racks 28 and 71 in a phase-matched state between the pair of rack and pinion mechanisms 30 and 70. Therefore, when the head unit 20 or the cap unit 62 is exchanged or the like, the head unit 20 or the cap unit 62 can be attached to the apparatus main body in a normal posture. Further, since the head unit 20 or the cap unit 62 is moved by the rack and pinion mechanisms 30 and 70, the head unit 20 or the cap unit 62 can be easily moved when the head unit 20 or the cap unit 62 is exchanged or the like. Further, since the rack and pinion mechanisms 30 and 70 are paired, the head unit 20 or the cap unit 62 can be stably moved even if the weight of the head unit 20 or the cap unit 62 is heavy.

2. The switching mechanisms 31 and 76 include the plug-in keys 282 and 712 provided on one of the racks 28 and 71, and the drive gears 43 and 72, and the grooves 433 and 723 provided on the other thereof and capable of meshing with the plug-in keys 282 and 712. When the head unit 20 or the cap unit 62 is attached, the meshing between the plug-in keys 282 and 712, and the grooves 433 and 723 of the switching mechanisms 31 and 76 is performed before the meshing between the racks 28 and 71, and the drive gears 43 and 72. When the plug-in keys 282 and 712, and the grooves 433 and 723 of the switching mechanisms 31 and 76 mesh with each other, the relative distance between the racks 28 and 71, and the drive gears 43 and 72 is narrowed, so that the racks 28 and 71, and the drive gears 43 and 72 can mesh with each other. When the plug-in keys 282 and 712, and the grooves 433 and 723 of the switching mechanisms 31 and 76 are not meshed with each other, the relative distance between the racks 28 and 71, and the drive gears 43 and 72 cannot be narrowed, so that the racks 28 and 71, and the drive gears 43 and 72 do not mesh with each other. Therefore, the plug-in keys 282 and 712, and the grooves 433 and 723 of the switching mechanisms 31 and 76 form a key structure. The meshing phases of the pair of rack and pinion mechanisms 30 and 70 can be matched by meshing between the plug-in keys 282 and 712, and the grooves 433 and 723 of the pair of switching mechanisms 31 and 76 provided in the pair of rack and pinion mechanisms 30 and 70. For example, compared to a lock mechanism that switches between unlocking/locking with a motor, since a drive source such as a motor is not required, the configuration is simple.

3. The phase of the plug-in keys 282 and 712 of the switching mechanisms 31 and 76, and the phase of the plug-in keys 282 and 712 of the rack and pinion mechanisms 30 and 70 are the same. Therefore, when the plug-in keys 282 and 712, and the grooves 433 and 723 of the pair of switching mechanisms 31 and 76 mesh with each other, the plug-in keys 282 and 712 of the pair of rack and pinion mechanisms 30 and 70 can mesh with each other in the same phase. For example, when the phases of the plug-in keys 282 and 712 of the switching mechanisms 31 and 76, and the phases of the tooth portions 28A and 43A (71A and 72A) of the rack and pinion mechanisms 30 and 70 are different, even if the plug-in keys 282 and 712, and the groove the 433 and 723 mesh with each other, there is a possibility that the tooth portions 28A and 43A (71A and 72A) of the rack and pinion mechanisms 30 and 70 do not mesh due to the phase shift. However, since the phases of the plug-in keys 282 and 712 of the switching mechanisms 31 and 76, and the phases of the tooth portions 28A and 43A (71A and 72A) of the rack and pinion mechanisms 30 and 70 are the same, when the plug-in keys 282 and 712, and the grooves 433 and 723 of the switching mechanisms 31 and 76 mesh with each other, the tooth portions 28A and 43A (71A and 72A) of the rack and pinion mechanisms 30 and 70 mesh with each other. Therefore, the pair of rack and pinion mechanisms 30 and 70 can be meshed with each other in the same phase. For example, the shape of the key structure of the switching mechanisms 31 and 76 is easily simplified.

4. One of the plug-in keys 282 and 712, and the grooves 433 and 723 of the switching mechanisms 31 and 76 is provided at a position where the tooth portions 28A and 71A of the pair of racks 28 and 71 mesh with each other in the same phase. Therefore, when the phases of the plug-in keys 282 and 712, and the grooves 433 and 723 of the pair of switching mechanisms 31 and 76 are different, the meshing is performed at different timings of the rotation positions one by one, and the posture of the head unit 20 or the cap unit 62 is inclined in the process of attaching the head unit 20 or the cap unit 62. This causes the head unit 20 or the cap unit 62 to be the phase shift and to be meshed. On the other hand, since the phases in which the plug-in keys 282 and 712, and the grooves 433 and 723 mesh with each other are the same between the pair of switching mechanisms 31 and 76, when the plug-in keys 282 and 712, and the grooves 433 and 723 of the pair of switching mechanisms 31 and 76 mesh with each other, the pair of rack and pinion mechanisms 30 and 70 can be meshed in the same phase.

5. The switching mechanisms 31 and 76 have the first portion on the drive gears 43 and 72 side, and the second portion on the racks 28 and 71 side. The first portion has the cylindrical flange portions 432 and 722 that are concentric with the tooth portions 43A and 72A of the drive gears 43 and 72, and have an outer diameter larger than the outer diameter of the tooth portions 43A and 72A, and the grooves 433 and 723 formed in the flange portions 432 and 722. Therefore, since the flanges provided in the drive gears 43 and 72 have a cylindrical shape having a diameter larger than the outer diameter of the tooth portion, the drive gears 43 and 72 can idle until the switching mechanisms 31 and 76 mesh with each other. When the plug-in keys 282 and 712, and the grooves 433 and 723 of the switching mechanisms 31 and 76 mesh with each other while the drive gears 43 and 72 are idling, the tooth portions 28A and 43A (71A and 72A) of the rack and pinion mechanisms 30 and 70 can mesh with each other.

6. The drive gears 43 and 72 have first teeth 431 and 721, and the racks 28 and 71 have first teeth 281 and 711. The switching mechanisms 31 and 76 have the plug-in keys 282 and 712, which are an example of the second teeth having the meshing longer than meshing of the first teeth 281, 431, 711, and 721. The depth of meshing with the grooves 433 and 723 by the plug-in keys 282 and 712 is longer than the meshing depth by the first teeth 281, 431, 711, and 721, and the meshing is performed at the switching position. Therefore, when the rack and pinion mechanisms 30 and 70 are at the switching position, the plug-in keys 282 and 712, and the grooves 433 and 723 of the switching mechanisms 31 and 76 mesh with each other. Therefore, the first teeth 281, 431, 711, and 721 of the rack and pinion mechanisms 30 and 70 mesh with each other. Therefore, the pair of rack and pinion mechanisms 30 and 70 can be meshed with each other in the same phase.

7. The tooth portions of the switching mechanisms 31 and 76 are provided at positions different from the tooth portions 28A and 43A (71A and 72A) of the rack and pinion mechanisms 30 and 70 in the axial direction of the drive gears 43 and 72. Therefore, by rotating the drive gears 43 and 72 a plurality of times, the diameter of the drive gears 43 and 72 can be reduced and the meshing by the plug-in keys 282 and 712 can be lengthened (the first teeth on the racks 28 and 71 side are used only for one rotation). For example, the switching mechanisms 31 and 76 provided in the rack and pinion mechanisms 30 and 70 disclosed in JP-A-2018-20463 are provided with the plug-in keys 282 and 712 longer than the first teeth at the same position as the first teeth of the drive gears 43 and 72 in the axial direction. In this case, since the drive gears 43 and 72 can rotate less than one revolution, the larger the distance the racks 28 and 71 move, the larger in size the drive gears 43 and 72 in the radial direction is. On the other hand, since the switching mechanisms 31 and 76 are shifted in position from the rack and pinion mechanisms 30 and 70 in the axial direction of the drive gears 43 and 72, the drive gears 43 and 72 can be rotated a plurality of times, and it is possible to suppress that the switching mechanisms 31 and 76 are increased in size in the radial direction by the drive gears 43 and 72, or even if the size is increased, a degree of the increase can be kept small.

8. The length of the racks 28 and 71 is longer than the length of one circumference of the drive gears 43 and 72. Therefore, the rack and pinion mechanisms 30 and 70 can move the head unit 20 or the cap unit 62 over a long distance. Further, since the drive gears 43 and 72 are rotated a plurality of times, it is possible to suppress the increase in size of the drive gears 43 and 72 in the radial direction. The switching mechanisms 31 and 76 are provided at different positions in the axial direction of the drive gears 43 and 72 with respect to the meshing locations between the tooth portions of the drive gears 43 and 72, and the tooth portions of the racks 28 and 71. Therefore, since the switching mechanisms 31 and 76 do not interfere with the meshing locations of the tooth portions of the rack and pinion mechanisms 30 and 70, the drive gears 43 and 72 can be rotated a plurality of times.

9. The pair of rack and pinion mechanisms 30 and 70 are provided on both sides in the width direction Y intersecting the moving direction of the head unit 20 or the cap unit 62. In the width direction Y of the head unit 20 or the cap unit 62, the first teeth 281 and 711 of the rack and pinion mechanisms 30 and 70 are on the head unit 20 or the cap unit 62 side with respect to the plug-in keys 282 and 712 of the switching mechanisms 31 and 76. Therefore, the first teeth 281 and 711, and the head 20H can be brought close to each other in the axial direction of the drive gears 43 and 72. Therefore, the space occupied by the head 20H can be reduced by lifting and lowering, so that the product can be easily miniaturized in the axial direction.

10. The printer 1 further includes the guide rail 38 as an example of the first guide portion for guiding the head unit 20, and the guide rail 37 as an example of the second guide portion. The guide rail 38 extends from the exchange position PH4 of the head unit 20 in the second direction intersecting the first direction in which the rack 28 extends. The guide rail 37 extends from the exchange position PH4 in the first direction. Therefore, after the rack 28 and the drive gear 43 are meshed by the guide rail 38, when the head 20H is lifted and lowered, the head 20H can be continuously guided by the guide rail 37 (from the guide rail 38). The rollers, protrusions, and bearings that move with respect to the guide rail can be shared by the guide rails 37 and 38.

11. By rotating the drive gears 43 and 72 in the direction in which the head unit 20 or the cap unit 62 moves in the gravity direction −Z, the switching mechanisms 31 and 76 mesh with each other. Therefore, after the switching mechanisms 31 and 76 are meshed, it is not necessary to provide a space on the opposite side for the head unit 20 or the cap unit 62 to move, and the apparatus can be easily miniaturized. Further, due to the self-weight of the head unit 20 or the cap unit 62, the gravitational urging in the direction in which the switching mechanisms 31 and 76 mesh with each other can be used.

12. The rack and pinion mechanisms 30 and 70 include the first rack and pinion mechanisms 30A and 70A, and the second rack and pinion mechanisms 30B and 70B. The first rack and pinion mechanisms 30A and 70A, and the second rack and pinion mechanisms 30B and 70B are provided on one end side and the other end side of the head 20H in the third direction that intersects both the first direction and the second direction intersecting the direction in which the racks 28 and 71 extend. Therefore, since the rack and pinion mechanisms 30 and 70 are provided on both sides, the head 20H can be lifted and lowered in a stable manner. In the example, the key structures at both ends are also rotated in synchronization.

13. The manufacturing method of the printer 1 includes the inputting step and the meshing step. The printer 1 includes the head unit 20 or the cap unit 62 as an example of the movable body, the pair of rack and pinion mechanisms 30 and 70 that move the head unit 20 or the cap unit 62 in the first direction in which the racks 28 and 71 extend, and the switching mechanisms 31 and 76 that switch the presence and absence of the meshing between the racks 28 and 71, and the drive gears 43 and 72 when the movable body is at the exchange position. In the inputting step, the head unit 20 or the cap unit 62 is placed in a state where the racks 28 and 71 face the drive gears 43 and 72. In the meshing step, the drive gears 43 and 72 are rotated to mesh the switching mechanisms 31 and 76, so that the pair of rack and pinion mechanisms 30 and 70 are meshed with each other in the same phase. According to this manufacturing method, since the switching mechanisms 31 and 76 are provided for each of the rack and pinion mechanisms 30 and 70, when the head unit 20 or the cap unit 62 is attached to the apparatus main body, the drive gears 43 and 72, and the racks 28 and 71 can relatively easily mesh with each other between the pair of rack and pinion mechanisms 30 and 70 in a phase-matched state. Therefore, the head unit 20 or the cap unit 62 can be attached to the apparatus main body in the normal posture.

The above embodiment can also be changed to forms such as modified examples illustrated below. Further, a further modified example may be a combination of the above embodiment and the modified examples illustrated below, and a combination of the modified examples illustrated below may be a further modified example.

In the embodiment, the rack is provided on the movable body and the drive gear is provided on the apparatus main body side, but the reverse is also possible. That is, the drive gear may be provided on the movable body, and the rack may be provided on the apparatus main body side. For example, the drive gear may be provided on the head 20H, and the rack may be provided on the apparatus main body side. Further, for example, the drive gear may be provided on the cap unit 62 and the rack may be provided on the apparatus main body side.

The number of rack and pinion mechanisms provided on the movable body may include a pair (two), and may be provided with three or more. For example, the three or more rack and pinion mechanisms may be provided in a state where the rack extends in a direction parallel to the first direction A.

The switching mechanism may be provided in the rack and pinion mechanism of only one movable body of the head and the cap unit 62. In this case, the other moving mechanism that does not include the switching mechanism may be the rack and pinion mechanism, or may be the moving mechanism other than the rack and pinion mechanism, for example, a belt type moving mechanism.

The movable body may be configured of only the head or may be configured of only the cap unit 62 of the head and the cap unit 62. In the former case, the cap unit 62 may be movable or fixed. Further, in the latter case, the head may be movable or fixed.

The movable body is not limited to the head unit 20 and the cap unit 62, and may be other than these. For example, the movable body may be a wiper unit or a flushing unit. The switching mechanism may be applied to the pair of rack and pinion mechanisms provided on the movable body other than these.

The maintenance unit is not limited to the cap unit, and may be the wiper unit or the flushing unit. For example, a rack and pinion mechanism that allows the wiper unit to move in the moving direction and a switching mechanism that switches the meshing of the rack and pinion mechanism may be provided. Further, for example, a rack and pinion mechanism that allows the flushing unit to move in the moving direction and a switching mechanism that switches the rack and pinion mechanism may be provided.

The height of the first tooth and the height of the second tooth of the rack may be changed.

The control section 26 may have a software configuration with which a computer executes a program such as a CPU, or a hardware configuration by an electronic circuit such as an ASIC. Further, the control section 26 may be configured by cooperation of software and hardware.

The medium P is not limited to paper, and may be a synthetic resin film, medium, cloth, non-woven fabric, laminated medium, or the like.

The liquid ejecting apparatus is not limited to the ink jet printer 1, and the liquid ejecting apparatus may be an ink jet printing apparatus. Further, the liquid ejecting apparatus may be a multifunction apparatus having a scanner mechanism and a copy function in addition to the recording function.

The liquid ejecting apparatus is not limited to the ink jet type printer 1, and may be an apparatus that ejects a liquid other than ink. For example, a liquid ejecting apparatus may be provided which ejects a liquid substance including functional materials such as an electrode material and a coloring material (pixel material) used in the manufacture of a liquid crystal display, an electroluminescence (EL) display, or a surface emitting display in a form of dispersion or dissolution. Further, it may be a liquid ejecting apparatus that ejects a bioorganic substance used for the manufacture of a biochip, or a liquid ejecting apparatus that ejects a liquid that is a sample used as a precision pipette. Further, it may be a liquid ejecting apparatus that ejects a transparent resin liquid such as a thermosetting resin onto a substrate to form a microhemispherical lens (optical lens) used for an optical communication element, a liquid ejecting apparatus that ejects etching liquid such as an acid or an alkali to etch the substrate, or the like, or a liquid ejecting apparatus that ejects a fluid substance such as a gel (for example, a physical gel). Further, the liquid ejecting apparatus may be a 3D printer for three-dimensional modeling that ejects a photocurable resin liquid by an ink jet method to form a three-dimensional object.

Hereinafter, the technical concept grasped from the above-described embodiment and modified examples will be described together with the effects.

A. A liquid ejecting apparatus includes a movable body including a head for ejecting a liquid or a maintenance section performing maintenance of the head, a pair of rack and pinion mechanisms including a rack and a drive gear to move the movable body in a first direction in which the rack extends, and a switching mechanism provided for each of the rack and pinion mechanisms and switching presence and absence of meshing between the rack and the drive gear when the movable body is at an exchange position.

According to this configuration, since each rack and pinion mechanism has the switching mechanism, the movable body can be relatively easily attached when being attached to the apparatus main body for exchange or maintenance of the movable body. Moreover, the switching mechanism allows the movable body to be attached to the apparatus main body in a normal posture. Therefore, an attachment operation of attaching the movable body to the apparatus main body in the normal posture can be easily performed.

B. In the liquid ejecting apparatus, the switching mechanism may include a tooth portion provided on one of the rack and the drive gear, and a groove provided on the other side and configured to mesh with the tooth portion. When the movable body is attached, the meshing between the tooth portion and the groove of the switching mechanism may be performed before the meshing between the rack and the drive gear. When the tooth portion and the groove of the switching mechanism may mesh with each other, a relative distance between the rack and the drive gear may be narrowed so that the rack and the drive gear are configured to mesh with each other. When the tooth portion and the groove of the switching mechanism do not mesh with each other, the relative distance between the rack and the drive gear may not be narrowed, and the rack and the drive gear do not mesh with each other.

According to this configuration, the tooth portion and the groove of the switching mechanism form a key structure, and the tooth portion and the grooves of the pair of switching mechanisms provided in the pair of rack and pinion mechanisms mesh with each other, so that the phase of the meshing of the pair of rack and pinion mechanisms can be matched.

C. In the liquid ejecting apparatus, a phase of the tooth portion of the switching mechanism and a phase of the tooth portion of the rack and pinion mechanism may be the same.

According to this configuration, when the tooth portion and the groove of the pair of switching mechanisms mesh with each other, the tooth portions of the pair of rack and pinion mechanisms can mesh with each other in the same phase. For example, when the phase of the tooth portion of the switching mechanism and the phase of the tooth portion of the rack and pinion mechanism are different, even if the tooth portion and the groove of the switching mechanism mesh with each other, there is a possibility that the tooth portions of the rack and pinion mechanism do not mesh each other caused by the phase shift. However, since the phase of the tooth portion of the switching mechanism and the phase of the tooth portion of the rack and pinion mechanism are the same, when the tooth portion and the groove of the switching mechanism mesh with each other, the tooth portions of the rack and pinion mechanism mesh with each other. Therefore, the pair of rack and pinion mechanisms can be meshed with each other in the same phase.

D. In the liquid ejecting apparatus, one of the tooth portion and the groove of the switching mechanism may be provided at a position where tooth portions of a pair of the racks mesh with each other in the same phase.

According to this configuration, when the phases of the tooth portion and the grooves of the pair of switching mechanisms are different, the meshing is performed at different timings of the rotation positions one by one, and the posture of the movable body is inclined in the process of attaching the movable body. This causes the movable body to be out of phase and to be meshed. On the other hand, since the tooth portion and the groove mesh with each other in the same phase between the pair of switching mechanisms, when the tooth portion and the groove of the pair of switching mechanisms mesh with each other, the pair of rack and pinion mechanisms can be meshed with each other in the same phase.

E. In the liquid ejecting apparatus, the switching mechanism may have a first portion on a drive gear side and a second portion on a rack side, and the first portion may have a cylindrical flange that is concentric with a tooth portion of the drive gear and have an outer diameter larger than an outer diameter of the tooth portion, and the groove that is formed in the flange.

According to this configuration, since the flange provided on the drive gear has the cylindrical shape having the diameter larger than the outer diameter of the tooth portion, the drive gear can idle until the switching mechanism meshes. When the tooth portion and the groove of the switching mechanism mesh with each other while the drive gear is idling, the tooth portion of the rack and pinion mechanism can be meshed.

F. In the liquid ejecting apparatus, the drive gear and the rack may have first teeth, the switching mechanism may have second teeth having meshing longer than meshing of the first teeth, and a depth of the meshing by the second teeth may be longer than a meshing depth of the first teeth and the meshing may be performed at a switching position.

According to this configuration, the depth of the meshing by the second teeth is longer than the meshing depth by the first teeth of the rack and pinion mechanism, and the meshing is performed at the switching position from a state where the first teeth of the rack and pinion mechanism do not mesh with each other to a state where the first teeth thereof mesh with each other. Therefore, when the rack and pinion mechanism is at the switching position, the second teeth and the groove of the switching mechanism mesh with each other, so that the first teeth of the rack and pinion mechanism mesh with each other. Therefore, the pair of rack and pinion mechanisms can be meshed in the same phase.

G. In the liquid ejecting apparatus, the tooth portion of the switching mechanism may be provided at a position different from the tooth portion of the rack and pinion mechanism in an axial direction of the drive gear.

According to this configuration, by rotating the drive gear a plurality of times, the meshing by the second teeth can be lengthened while reducing the diameter of the drive gear. For example, it is possible to suppress the increase in size of the liquid ejecting apparatus.

H. In the liquid ejecting apparatus, a length of the rack may be longer than a length of one circumference of the drive gear.

According to this configuration, the movable body can be moved over a long distance by the rack and pinion mechanism. Further, since the drive gear can be rotated a plurality of times, it is possible to suppress the increase in size of the drive gear in the radial direction. Since the switching mechanism is provided at different positions in the axial direction of the drive gear with respect to the meshing locations of a tooth portion of the drive gear and the tooth portion of the rack, the switching mechanism does not interfere with the meshing locations of the tooth portion of the rack and pinion mechanism. Therefore, the drive gear can be rotated a plurality of times.

I. In the liquid ejecting apparatus, the pair of rack and pinion mechanisms may be provided on both sides in a width direction intersecting a moving direction of the movable body, and first teeth of the rack and pinion mechanism may be provided on a movable body side with respect to second teeth of the switching mechanism in the width direction of the movable body.

According to this configuration, the first tooth and the movable body can be brought close to each other in the axial direction of the drive gear. Therefore, a space occupied by the movable body can be reduced by lifting and lowering, so that the product can be easily miniaturized in the axial direction.

J. In the liquid ejecting apparatus, a first guide portion and a second guide portion for guiding the movable body may be further provided, and the first guide portion may extend in a second direction that intersects the first direction in which the rack extends, from the exchange position of the movable body, and the second guide portion may extend in the first direction from the exchange position.

According to this configuration, after the rack and the drive gear are meshed by the first guide portion, the movable body can be continuously guided from the first guide portion by the second guide portion when the movable body is lifted and lowered. The rollers, protrusions, and bearings that move with respect to the guide rail can be shared between the first guide portion and the second guide portion.

K. In the liquid ejecting apparatus, the switching mechanism may be meshed by rotating the drive gear in a direction in which the movable body moves in a gravity direction.

According to this configuration, it is not necessary to provide a space for the movable body to move on the opposite side after the switching mechanism is meshed, and the apparatus can be easily miniaturized. Further, due to the self-weight of the movable body, the gravitational urging in the direction in which the switching mechanisms mesh with each other can be used.

L. In the liquid ejecting apparatus, the rack and pinion mechanism may include a first rack and pinion mechanism and a second rack and pinion mechanism, and the first rack and pinion mechanism and the second rack and pinion mechanism may be provided on one end side and the other end side of the movable body in a third direction intersecting both of the first direction and a second direction that intersects the direction in which the rack extends.

According to this configuration, since the rack and pinion mechanisms are provided on both sides, the movable body can be lifted and lowered in a stable manner.

M. A manufacturing method of a liquid ejecting apparatus including a movable body including a head for ejecting a liquid or a cap covering a nozzle surface of the head, a pair of rack and pinion mechanisms including a rack and a drive gear to move the movable body in a first direction in which the rack extends, and a switching mechanism provided for each of the rack and pinion mechanisms and switching presence and absence of meshing between the rack and the drive gear when the movable body is at an exchange position, the method including: an inputting step of placing the movable body in a state where the rack faces the drive gear; and a meshing step of rotating the drive gear to mesh the switching mechanism so that the pair of rack and pinion mechanisms are meshed with each other in the same phase.

According to this manufacturing method, since each rack and pinion mechanism has the switching mechanism, when the movable body is attached to the apparatus main body, the drive gear and the rack can be meshed in a state of the phases are matched the pair of rack and pinion mechanisms can be meshed in the same phase. Therefore, the movable body can be attached to the apparatus main body in a normal posture.

What is claimed is:

1. A liquid ejecting apparatus comprising:
a movable body including a head for ejecting a liquid or a maintenance section performing maintenance of the head;
a pair of rack and pinion mechanisms including a rack and a drive gear to move the movable body in a first direction in which the rack extends; and
a switching mechanism provided for each of the rack and pinion mechanisms and switching presence and absence of meshing between the rack and the drive gear when the movable body is at an exchange position.

2. The liquid ejecting apparatus according to claim 1, wherein
the switching mechanism includes a tooth portion provided on one of the rack and the drive gear, and a groove provided on the other side and configured to mesh with the tooth portion, and
when the movable body is attached,
the meshing between the tooth portion and the groove of the switching mechanism is performed before the meshing between the rack and the drive gear,
when the tooth portion and the groove of the switching mechanism mesh with each other, a relative distance between the rack and the drive gear is narrowed so that the rack and the drive gear are configured to mesh with each other, and
when the tooth portion and the groove of the switching mechanism do not mesh with each other, the relative distance between the rack and the drive gear is not narrowed, and the rack and the drive gear do not mesh with each other.

3. The liquid ejecting apparatus according to claim 2, wherein
a phase of the tooth portion of the switching mechanism and a phase of a tooth portion of the rack and pinion mechanism are the same.

4. The liquid ejecting apparatus according to claim 3, wherein
one of the tooth portion and the groove of the switching mechanism is provided at a position where tooth portions of a pair of the racks mesh with each other in the same phase.

5. The liquid ejecting apparatus according to claim 2, wherein
the switching mechanism has a first portion on the drive gear and a second portion on the rack, and
the first portion has a cylindrical flange that is concentric with a tooth portion of the drive gear and has an outer diameter larger than an outer diameter of the tooth portion, and the groove that is formed in the flange.

6. The liquid ejecting apparatus according to claim 1, wherein
the drive gear and the rack have first teeth, and
the switching mechanism has second teeth having meshing longer than meshing of the first teeth, and a depth of the meshing by the second teeth is longer than a meshing depth of the first teeth and the meshing is performed at a switching position.

7. The liquid ejecting apparatus according to claim 1, wherein
the tooth portion of the switching mechanism is provided at a position different from the tooth portion of the rack and pinion mechanism in an axial direction of the drive gear.

8. The liquid ejecting apparatus according to claim 1, wherein
a length of the rack is longer than a length of one circumference of the drive gear.

9. The liquid ejecting apparatus according to claim 1, wherein
the pair of rack and pinion mechanisms are provided on both sides in a width direction intersecting a moving direction of the movable body, and first teeth of the rack and pinion mechanism are provided on a movable body side with respect to second teeth of the switching mechanism in the width direction of the movable body.

10. The liquid ejecting apparatus according to claim 1, further comprising:
a first guide portion and a second guide portion for guiding the movable body, wherein
the first guide portion extends in a second direction that intersects the first direction in which the rack extends, from the exchange position of the movable body, and
the second guide portion extends in the first direction from the exchange position.

11. The liquid ejecting apparatus according to claim 1, wherein
the switching mechanism is meshed by rotating the drive gear in a direction in which the movable body moves in a gravity direction.

12. The liquid ejecting apparatus according to claim 1, wherein
the rack and pinion mechanism includes a first rack and pinion mechanism and a second rack and pinion mechanism, and
the first rack and pinion mechanism and the second rack and pinion mechanism are provided on one end side and the other end side of the head in a third direction intersecting both of the first direction and a second direction that intersects the direction in which the rack extends.

13. A manufacturing method of a liquid ejecting apparatus including
a movable body including a head for ejecting a liquid or a cap covering a nozzle surface of the head,
a pair of rack and pinion mechanisms including a rack and a drive gear to move the movable body in a first direction in which the rack extends, and
a switching mechanism provided for each of the rack and pinion mechanisms and switching presence and absence of meshing between the rack and the drive gear when the movable body is at an exchange position, the method comprising:
an inputting step of placing the movable body in a state where the rack faces the drive gear; and
a meshing step of rotating the drive gear to mesh the switching mechanism so that the pair of rack and pinion mechanisms are meshed with each other in the same phase.
